(19) United States
(12) Patent Application Publication
(10) Pub. No.: US 2024/0112015 A1
(43) Pub. Date: Apr. 4, 2024

(54) TRAINING A RECURRENT NEURAL NETWORK MACHINE LEARNING MODEL WITH BEHAVIORAL DATA

(71) Applicant: PayPal, Inc., San Jose, CA (US)

(72) Inventor: Adam Inzelberg, Tel Aviv (IL)

(21) Appl. No.: 17/954,137

(22) Filed: Sep. 27, 2022

(51) Int. Cl. G06N 3/08; G06N 20/20

(52) U.S. Cl. CPC G06N 3/08; G06N 20/20

(57) ABSTRACT

The method, system and a computer program product are directed to an ensemble machine learning model that receives account parameters as input. The ensemble machine learning model includes a graphical neural network model, an auto encoder and a recurrent neural network model. The ensemble machine learning model converts a plurality of account parameters into an entity graph, an entity embedding and a sequence of account parameters for the ensemble machine learning model. The graphical neural network model, the auto encoder and the recurrent neural network model determine whether the account exhibits the pre-determined behavior based on the entity graph, the entity embedding and the sequence of account parameters.

### FIELD OF INVENTION

The embodiments generally relate to machine learning, and more particularly to using transaction data to train an ensemble of models to make predictions of entity behavior.

### BACKGROUND

In the past several decades, rapid advances were made in computer technology and telecommunications. As a result, more and more interactions are conducted electronically. For example, electronic online transaction platforms such as PAYPAL™, VENMO™, EBAY™, AMAZON™ or FACEBOOK™ allow their users to conduct transactions with other users, other entities, or institutions. These transactions and associated transaction metadata may exhibit behavior patterns of the entities conducting the transactions. However, conventional technology is unable to leverage transaction data associated with an entity to predict behavior of the entities.

### BRIEF DESCRIPTION OF THE FIGURES

FIG. 1 is a block diagram of a networked system, according to various aspects of the disclosure.

FIG. 2 illustrates various types of activities or events that are part of an account parameter, according to various aspects of the disclosure.

FIG. 3 illustrates a process for generating an event code, according to various aspects of the disclosure.

FIG. 4 illustrates a process for training a machine learning model, according to various aspects of the disclosure.

FIG. 5 illustrates a list of activities of an entity over a period of time, according to various aspects of the disclosure.

FIGS. 6-11 illustrates an example system involving various types of neural networks for machine learning, according to various aspects of the disclosure.

FIGS. 12A-12D illustrate an example system involving neural networks, according to various aspects of the disclosure.

FIG. 13 is a flowchart illustrating a method for determining whether an account exhibits a pre-determined behavior, according to various aspects of the disclosure.

FIG. 14 is an example computer system according to various aspects of the disclosure.

FIG. 15 is a simplified example of a cloud-based computing architecture according to various aspects of the present disclosure.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the disclosure. Specific examples of components and arrangements are described below to simplify the disclosure. These are, of course, merely examples and are not intended to be limiting. Various features may be arbitrarily drawn in different scales for simplicity and clarity.

The disclosure pertains to a machine learning model for predicting the behavior of an entity based on account parameters of an account associated with the entity. Machine learning pertains to a paradigm for determining an embedding function based on a dataset that includes an input and a corresponding output. This paradigm is different from an explicit programming of a system which relies on the system being provided a computer program that includes instructions that describe how to obtain an output given an input.

The dataset may be used to train a machine learning model. In an example, the system may receive a training dataset that includes pictures of fruits with labels such as apples, where the input is the picture, and the output is the label. This high dimensional dataset of pictures of fruits includes one or more manifolds that describe the key features of an apple that may identify apples and non-apples.

According to a manifold hypothesis, a real world dataset includes one or more low-dimensional manifolds. A manifold is a framework for describing spaces like spheres, tori (donut shaped spaces), mobius bands, and the like in the n-dimensional space. A manifold may be understood more readily as an extension of a Euclidian geometric space. For example, a line or a curve in a two dimensional Euclidian space may be represented in an X-Y graph, and when the dimensions increase from two dimensions to n-dimensions, mathematicians use the term manifolds to describe the objects in the n-dimensional space. Machine learning unravels these low-dimensional manifolds to define boundaries between features in the input and relate the features to the output. This is similar to how human brains process real world datasets.

During training of a machine learning model, the system determines an embedding function that identifies the manifold in the dataset without explicit programming of the embedding function. The training is based on various machine learning algorithms. The trained machine learning model may use features in the images of fruits to demarcate inputs that constitute e.g., apples and features in the images that do not constitute apples.

A system may train a machine learning model on one or more machine learning algorithms. The embedding function may describe the relationship between one or more features in the input and the corresponding output. The input features may be visible features or hidden features. The input features may be low dimensional manifolds in the dataset. For example, the machine learning model may identify the low dimensional manifolds in images of an apple to determine the image is an apple. The trained machine learning model may be described as a program that includes an embedding function that demarcates the boundary between different inputs in an n-dimensional space that produce different outputs based on one or more features in the inputs. The embedding function may demarcate a boundary between inputs or input features that would be labelled as apples and those that are not labelled as apples when the manifold is unraveled from the high-dimensional dataset. Training a machine learning model is the process of identifying the embedding function that describes the manifold in a dataset based on a machine learning algorithm. The trained machine learning model can interpret an input (which may or may not be previously seen by the model) and determine an output based on the embedding function.

The system may determine the embedding function based on different machine learning algorithms. Machine learning algorithms may be classified into different paradigms such as symbolic logic, statistical inference, analogistic reasoning, neural networks, and generic algorithms. Examples of symbolic logic machine learning paradigms include decision trees, random decision forests, production rules systems, and inductive logic programming. Examples of neural network paradigms include artificial neural networks, reinforcement learning, and deep learning. Examples of statistical or Bayesian machine learning paradigms include hidden Markov chains, graphical model and causal inference model. Examples of evolutionary machine learning paradigms include genetic algorithms. Examples of analogistic machine learning paradigms include k-nearest neighbors, support vector machines and the like. The various machine learning paradigms may be used to determine the embedding function of the machine learning model in the n-dimensional space that relates features in the input to different outputs. The embedding function demarcates the boundary between different inputs in a machine learning model that produce different outputs. The embedding function allows the trained machine learning model to interpret an input after training to produce an output without explicit programming.

An artificial neural network may be based on a biological neural network that emulates a brain having neurons that are interlinked to each other. The artificial neural network includes layers of nodes, including an input layer, one or more hidden layers and an output layer. A node in a layer of the artificial neural network connects to another and has an associated weight and a threshold. If the output of an individual node is above the specified threshold value, that node is activated, sending data to the next layer of the network. If the output of the individual node is below the specified threshold value, no data is passed along to the next layer of the network. Neural networks rely on training data to learn and improve their accuracy over time. However, once these neural networks are finetuned for accuracy, the neural networks may classify and cluster data at a high velocity.

The node of an artificial neural network may be described as a linear regression model, composed of input data, weights, a bias (or threshold), and an output. The node may be modeled as follows:

Σwixi+bias=w1x1+w2x2+w3x3+bias Equation (1)

output=ƒ(x)=1 if Σw1x1+b>=0; 0 if Σw1x1+b<0 Equation (2)
where w1, w2, and w3 are the weights for each of the inputs x1, x2, and x3.

During training of the artificial neural network, the weights of the layers and the nodes in the layers are assigned. The weights of the neural network represent the importance of a feature of the input and the contribution of the input to the output. The node of the artificial neural network is activated based on the summation of weighted inputs based in the input values received at the nodes. The node fires or activates when the output exceeds a threshold value or bias of the node. The firing of the node causes the output of that node to become an input of the next node. In some instances, the neural network that passes data from one layer to the next layer is called a feedforward network.

The system may train the artificial neural network on a cost or loss function. For example, the system may determine a mean squared error between the actual output and the expected output, which is the cost or loss. The system may then use back propagation to minimize the cost or loss function. The process of training the artificial neural network may be described as unraveling the manifold in the dataset to determine an embedding function that relates features of the input data to the output data in the artificial neural network with minimum cost or loss. Back propagation is the process of calculating and attributing the error associated with neurons in the artificial neural network, and adjusting and fitting the parameters, e.g., weights of the nodes in the model appropriately. A gradient descent algorithm is one example of a loss function that may be used during back propagation to determine the embedding function that fits the training data. Examples of artificial neural networks include perceptrons, multi-layer perceptrons, convolutional neural networks, recurrent neural networks and Long Short-Term Memory (LSTM) networks.

The dataset that may train the machine learning model or be interpreted by the machine learning model may include structured data, unstructured data or both. Examples of structured data include sensor data, computer generated logs, computer representation of speech, video or pictures and the like. Examples of unstructured data include human behavior data, textual data, side channel data from processors, information from networks such as social networks and the like. The structured and unstructured data may be conditioned or pre-processed using one or more algorithms before being used for training or interpretation in the machine learning model.

The embodiments are directed to an artificial neural network that is trained to determine whether an account associated with an entity exhibits a pre-determined behavior based on account parameters. The artificial neural network may include a first machine learning model layer, a second machine learning model layer, and a third machine learning model layer. Each layer may include a different machine learning model. Each machine learning model layer may identify same or different pre-determined account behavior. In an example, the first machine learning model layer may be a graphical neural network (GNN) layer, the second machine learning model layer may be an auto encoder layer, and the third machine learning model layer may be a LSTM Layer. The embodiments described herein may pre-process the account parameters into a first set of parameters, a second set of parameters, and a third set of parameters. For example, the first set of parameters may be an entity graph, a second set of parameters may uniquely identify the account, and a third set of parameters may be a sequence of events that transpired at some point in time and is associated with the account. The first, second, and third sets of parameters are inputs to different machine learning model layers of the artificial neural network. The first, second, and third machine learning model layers may receive the respective parameters and determine whether the account exhibits a pre-determined behavior. For example, the first machine learning model layer may determine whether the first entity graph is associated with a first pre-determined behavior. The second machine learning model layer may determine whether the account exhibits a second pre-determined behavior based a vector proximity between the first entity embedding associated with the account and a second entity embedding in an n-dimensional vector space. The second entity embedding may be associated with a second account that exhibits the second pre-determined behavior. The third machine learning model layer may determine whether the account exhibits a third pre-determined behavior based on a sequence of a third set of parameters. The artificial neural network determines the probability that the account exhibits the pre-determined behavior based on the one or more of the first pre-determined behavior, the second pre-determined behavior, and the third pre-determined behavior.

The artificial neural network may be trained using various training datasets, such as a first training dataset, a second training dataset, and a third training dataset. Each dataset may train a different machine learning model layer of the artificial neural network. The first training dataset may include entity graphs associated with entities that exhibit the first pre-determined behavior and entity graphs associated with entities that do not exhibit the first pre-determined behavior. The second training dataset may include a set of entities that exhibit the second pre-determined behavior and a set of entities that do not exhibit the second pre-determined behavior. The third training dataset may include a set of entities that exhibit the third pre-determined behavior and a set of entities that do not exhibit the third pre-determined behavior and a corresponding sequence of a third set of parameters. Suppose the artificial neural network includes three layers, such as a GNN model layer, an auto encoder model layer, and an LSTM model layer. The first training dataset may train the GNN model layer, the second training dataset may train the auto encoder model layer and the third training dataset may train the LSTM model layer.

Some examples of pre-determined behavior may include fraud, behavior that is harmful to a service provider, behavior of high value customers of the service provider, behavior indicating value in a loan offer, behavior indicating likelihood of accepting or requiring a loan, behavior indicating a high-network or status, behavior indicating money spent on high end purchases, and the like. The presence of pre-defined behavior or lack thereof is merely a non-limiting example of the predefined status. Other examples of the predefined status may include an award, a premium membership, a grant of a request, and the like.

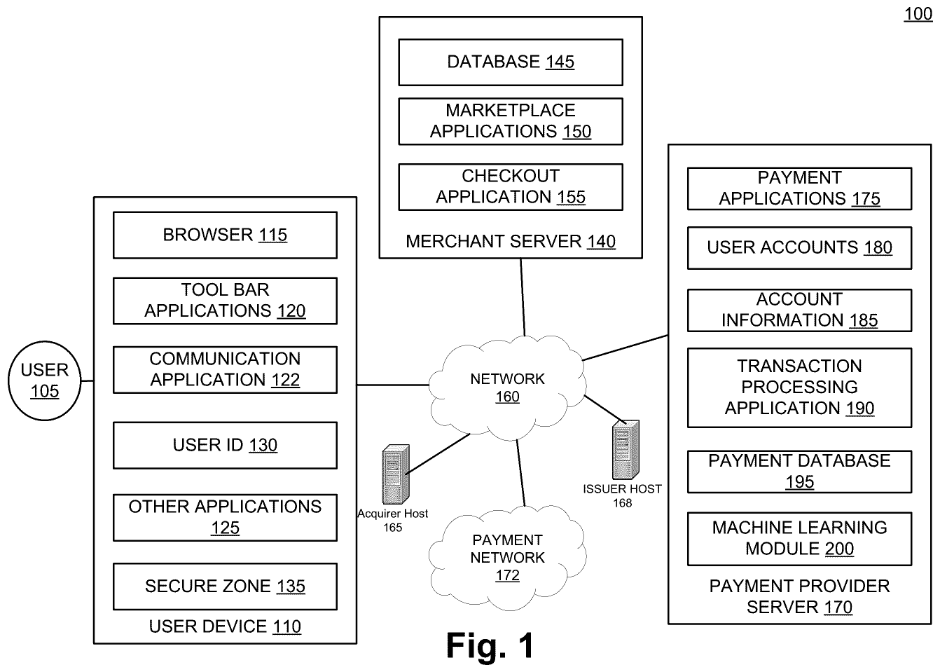

Once the artificial neural network is trained, the artificial neural network may make predictions involving other entities as discussed above. The various embodiments are discussed in more detail with reference to FIGS. 1-15.

FIG. 1 is a block diagram of a networked system 100 or architecture suitable for conducting electronic online transactions according to an embodiment. Networked system 100 may comprise or implement a plurality of servers and/or software components that operate to perform various transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a payment service provider, such as PayPal™, Inc. of San Jose, CA. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, and the like. Although only one merchant server 140 is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. User device 110 may be implemented as a personal computer (PC), a smart phone, a smart phone with additional hardware such as NFC chips, BLE hardware and the like, a wearable device with similar hardware configurations such as a gaming device, a Virtual Reality Headset, or a device that talks to the smart phone with unique hardware configurations and running appropriate software. User device 110 may also be implemented as a laptop computer, and/or another type of a computing device capable of transmitting and/or receiving data, such as an iPad™ from Apple™.

User device 110 may include one or more browser applications 115 which may be used, for example, to provide a convenient interface to permit user 105 to browse information available over network 160. Browser application 115 may be implemented as a web browser configured to view information available over the Internet, such as a user account for online shopping and/or merchant sites for viewing and purchasing goods and services.

User device 110 may also include one or more toolbar applications 120 which may be used, for example, to provide client-side processing for performing desired tasks in response to operations selected by user 105. Toolbar application 120 may display a user interface in connection with browser application 115.

User device 110 also may include other applications 125 to perform functions, such as email, texting, voice, and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers (or simply user IDs) 130 which may be implemented, for example, as operating system registry entries, cookies associated with browser application 115, identifiers associated with hardware of user device 110, or other appropriate identifiers, such as identifiers used for payment, user, and/or device authentication. In one embodiment, user identifier 130 may be used by a payment service provider to associate user 105 with a particular account maintained on the payment provider server 170. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials or other data that may warrant a more secure or separate storage, including various data as described herein.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser application 115 of user device 110. In one embodiment, user 105 may interact with marketplace application 150 through browser applications over network 160 in order to view various products, food items, or services identified in database 145.

According to various embodiments, the merchant server 140 may also host a website for an online marketplace, where sellers and buyers may engage in purchasing transactions with each other. The descriptions of the items or products offered for sale by the sellers may be stored in the database 145. For example, the descriptions of the items may be generated (e.g., by the sellers) in the form of text strings. These text strings are then stored by the merchant server 140 in the database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, and the like. Payment application 175 may be further configured to determine the existence of and to manage accounts for user 105, as well as create new accounts if necessary.

According to some embodiments, a machine learning module 200 may also be implemented on the payment provider server 170. The machine learning module 200 may include one or more software applications or software programs that may automatically execute (e.g., without needing explicit instructions from a human user) to perform certain tasks. For example, the machine learning module 200 may electronically access one or more electronic databases (e.g., the payment database 195 of the payment provider server 170 or the database 145 of the merchant server 140, or both) to access or retrieve a plurality of account parameters about an entity. An example entity may be user 105, though the implementation is not limited to this embodiment. The plurality of account parameters may contain event data, which may pertain to various historical events involving the entity. For example, the event data for each event may indicate event features, such as whether the price and/or amount of a transaction conducted by the entity, whether the transaction is a peer-to-peer transaction, the payment flow of the transaction, whether the transaction was authorized, and the like. The machine learning module 200 may include an artificial neural network that includes an ensemble of models, such as a first machine learning model, a second machine learning model and a third machine learning model. In another example, the machine learning module may include an artificial neural network with multiple layers, where each layer is a different model, such as the first machine learning model, the second machine learning model, and the third machine learning model.

Machine learning module 200 may determine whether an account exhibits a pre-determined behavior. Using machine learning techniques such as a GNN, an auto encoder, and a recurrent neural network (RNN) or an LSTM (a type of RNN), the machine learning module 200 may determine whether an activity associated with the account exhibits certain pre-determined behavior. For example, the actions of the entity may be fraudulent based on the most recent or current behavior sequence of the entity.

It is noted that although the machine learning module 200 is illustrated as being separate from the transaction processing application 190 in the embodiment shown in FIG. 1, the transaction processing application 190 may implement some, or all, of the functionalities of the machine learning module 200. In other words, the machine learning module 200 may be integrated within the transaction processing application 190 in some embodiments. In addition, it is understood that the machine learning module 200 (or another similar program) may be implemented on the merchant server 140, on a server of any other entity operating a social interaction platform, or even on a portable electronic device similar to the user device 110 (but may belong to an entity operating the payment provider server 170) as well. It is also understood that the machine learning module 200 may include one or more sub-modules that are configured to perform specific tasks. For example, the machine learning module 200 may include a first sub-module configured to train the machine learning model, as well as a second sub-module configured to make predictions based on the trained model.

Still referring to FIG. 1, the payment network 172 may be operated by payment card service providers or card associations, such as DISCOVER™, VISA™, MASTERCARD™ AMERICAN EXPRESS™, RUPAY™, CHINA UNION PAY™, and the like. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

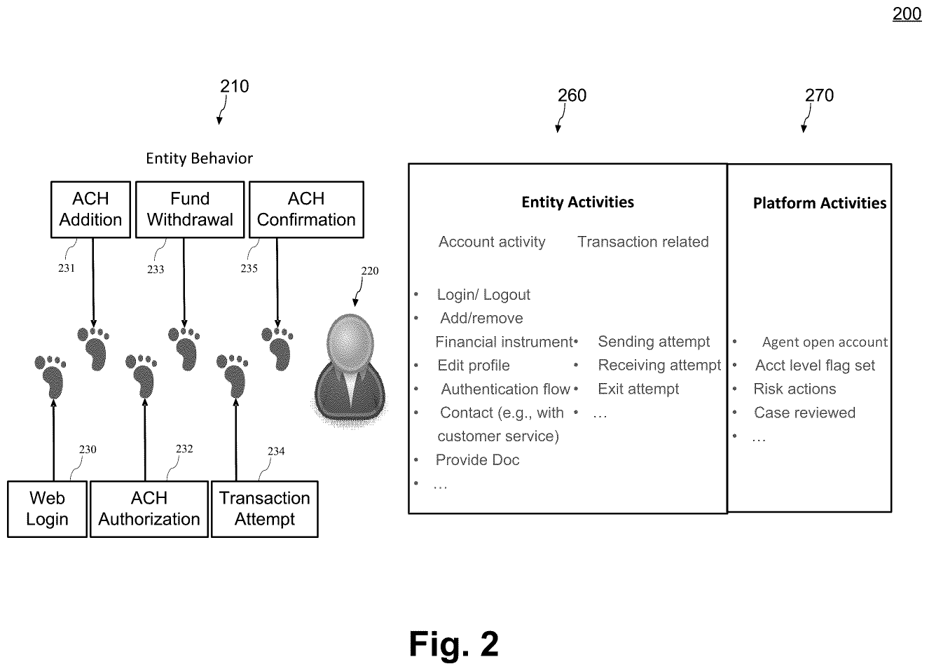

FIG. 2 is a diagram 202 illustrating various types of activities that may be analyzed using account parameters associated with an entity, according to some embodiments. FIG. 2 illustrates the account parameters of an entity 220, such as a merchant. The entity 220 may sell goods or services on an electronic transaction platform, such as EBAY™ or AMAZON™ The terms of seller and merchant may be used interchangeably hereinafter. As shown in FIG. 2, entity 220 may exhibit the entity behavior 210 which generates account parameters. Example entity behavior 210 may include the following activities or events:
1. A web login event 230. For example, the entity 220 may use a username and a password to log in to the electronic transaction platform.
2. An ACH addition event 231. For example, the entity 220 may add (e.g., over the web) an Automated Clearing House (ACH) account to be associated with the entity 220's account with the electronic transaction platform. ACH is a network that coordinates electronic payments and automated money transfers and allows entity 220 to move money between banks without using paper checks, wire transfers, credit card networks, or cash.
3. An ACH Authorization event 232. The entity 220 may authorize another entity (e.g., a company, a landlord, or a financial institution such as the electronic transaction platform discussed herein) to automatically deduct funds from the account of the entity 220. The funds may be deducted during regular intervals, such as in daily, weekly, or monthly cycles.
4. An ACH confirmation event 233. The electronic transaction platform may send confirmation to the entity 220 that the ACH added by the entity 220 has been successfully confirmed.
5. A transaction attempt event 234. The electronic transaction platform may receive an attempt from the entity 220 to conduct a transaction. An example may be to sell one or more products or services via the electronic transaction platform. Characteristics or features about the attempted transaction may be included in this event. For example, the characteristics or features may include whether the attempted transaction is a peer-to-peer transaction, the average selling price of the goods and/or services involved in the attempted transaction, and the like.
6. A fund withdrawal event 235. Entity 220 may withdraw the funds in the entity 220's account. Characteristics or features about fund withdrawal event 235 may include the amount withdrawn, the length of time between the withdrawal, a previous transaction or transaction attempt, and the like.

The activities or events discussed above may be included in entity account parameters 210. These examples are non-limiting as other activities and events may be analyzed and included a part of the entity account parameters 210. For example, additional entity activities 260 may include activities related to an account of the entity, such as a login or a logout attempt, an addition or a removal of a financial instrument (FI) (e.g., checking account, savings account, credit card number, and the like), an edit of a merchant profile, an authentication flow, a contact with other entities, such as with a customer service representative of the electronic transaction platform, or providing of certain documents. The additional entity activities 260 may also include activities related to one or more transactions, such as an attempt to send or sending funds, attempt to receive or receiving funds, attempt to exit out of the transaction, etc.

The above activities are example activities that may be initiated or triggered by entity 220. In addition, the activities that can be analyzed as a part of the account parameters data of the entity 220 may include platform activities 270 performed by the electronic transaction platform. As non-limiting examples, platform activities 270 may include using an agent to open an account for the entity 220, setting an account level flag (e.g., trustworthy user or fraudulent user) for the entity 220, performing risk actions (e.g., risk analysis actions or risk mitigation actions on entity 220), or reviewing cases associated with the entity 220, and the like. It is also understood that although the discussions pertain to an entity or merchant or seller on the electronic transaction platform, the same is true for a buyer on the electronic transaction platform. In other words, the activities of a buyer may be retrieved and analyzed to generate account parameters, which may then be used to train the artificial neural network within the machine learning module 200 discussed in FIG. 1.

Before the account parameters of the entity 220 or a buyer can be used to train the artificial neural network, the account parameters may be compressed or otherwise reconfigured to generate an entity graph, an entity embedding or a sequence of parameters or a combination thereof according to various aspects of the disclosure.

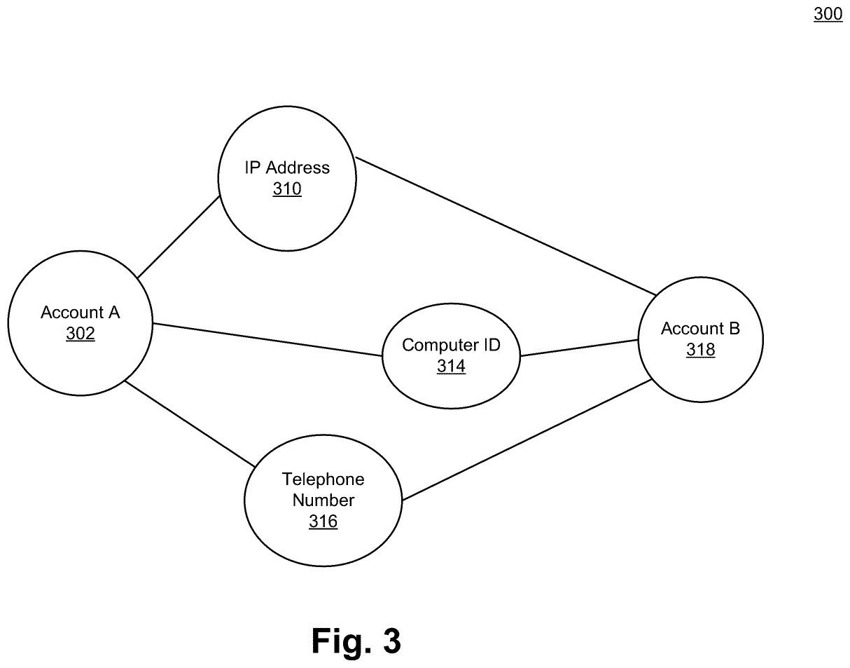

FIG. 3 is a diagram of an entity graph 300, according to some embodiments. Entity graph 300 may be generated from account parameters associated with an event, such as opening an account. The various features of the event may be extracted as a part of the account parameters of the entity and included in entity graph 300.

As discussed above, account parameters of an entity may include a first set of account parameters, a second set of account parameters, and a third set of account parameters. The account parameters may be converted into entity graph 300 that represents a first set of parameters. The entity graph 300 represents the relationships (edges) between the collection of entities (nodes). The entity graph 300 includes vertex attributes, edge attributes and global attributes. The vertex attributes of the entity graph may include the node identity and/or a number of neighbors. The edge attributes of the entity graph may include the edge identity and the edge weight. The global attributes of the entity graph may include the number of nodes, the longest path of the entity graph between the nodes in the first entity graph, and the like.

FIG. 3 illustrates features 310-316 as example features of the event. Features 310-316 may be represented as nodes in entity graph 300. Features may include an internet protocol address 310, a computer identifier 314, which may be an address such as a physical address or a computer ID associated with the account, and a telephone number 316 associated with the event. The account parameters may relate to the IP address, phone number, and address associated with an account, when the account is created as a part of the event. In another example, the account parameters may be for a transaction in which the entity sells goods or services. In this case, features 312-316 may relate an account A 302 associated with a first entity that conducts a transaction with a second entity associated with an account B 318. Notably the event may have other features associated with it which are excluded from entity graph 300 for simplicity.

In the artificial neural network, each feature may correspond to a dimension. This is because each feature can correspond to variables independent of other features or vary in a degree of freedom that is uncorrelated with other features. In FIG. 3, the event has multiple dimensions, with each of the features 310-316 corresponding to a different dimension. The artificial neural network may generate entity graph 300 based on the features that have vertices that are account A 302, account B 318, IP address 310, computer ID 314 and telephone number 316 associated with the account A 302.

During a training stage, entity graph 300 may be used to train the GNN model or the GNN layer of the artificial neural network.

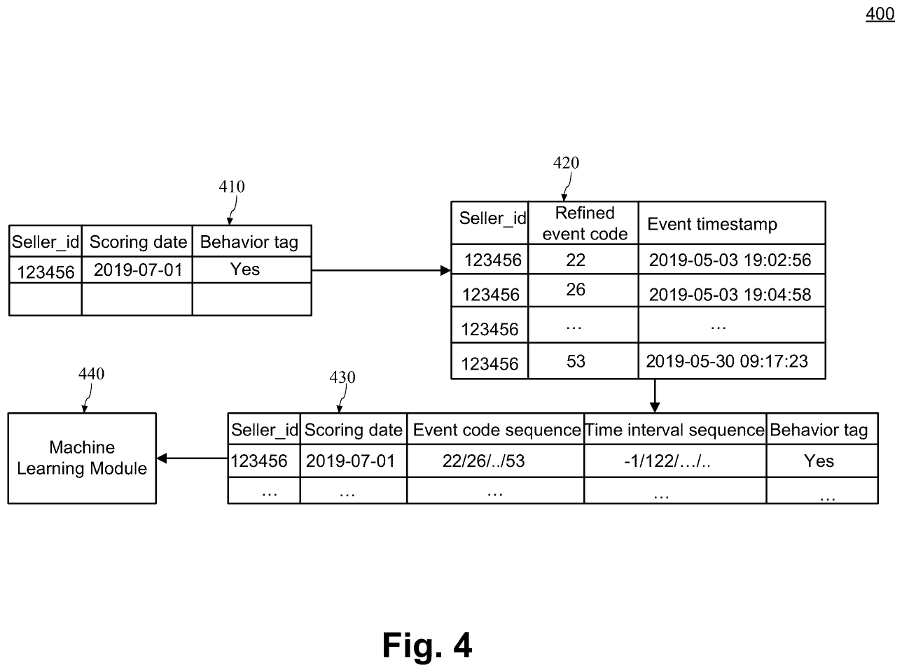

FIG. 4 is a block diagram of 400 of multiple data sequences corresponding to the account parameters of an entity, according to some embodiments. FIG. 4 includes diagrams 410, 420, and 430. Diagram 410 illustrates the account parameters associated with an entity. The account parameters may be retrieved from an electronic database(s) or computer logs, and may be information such as the IP address, the entity's relationship with other entities, the sequence of transactions since the account was opened and the like. As illustrated in diagram 410, the account parameters may be structured data. The structured data is data that may be compiled represented as a table.

In some embodiments, the entity may be a seller or a merchant using an electronic transaction platform. In other embodiments, the entity may be a buyer using the electronic transaction platform or may be another suitable entity that is neither a seller nor a buyer. As shown in diagram 410 of FIG. 4, the entity may have an identification code such as “123456” under the column Seller_id. Other entities may have different identification codes.

In some instances, a predefined status may be determined or assigned to the entity corresponding to Seller_id of 123456. The predefined status may be or indicate the presence of a behavior (e.g., high value entity or a presence of fraud) or the lack thereof, which may be represented by a value of “Yes” under the “Behavior Tag” column. The presence of behavior may be at an account level, or it may be at a transaction level. The presence of pre-defined behavior or the lack thereof is merely a non-limiting example of the predefined status. Other examples of the predefined status may include an award, a premium membership, a grant of a request, and the like.

The predefined status may be determined on a particular date (e.g., the “Scoring date”), which in diagram 410 is 2019-07-01. The electronic transaction platform or another suitable entity may determine the predefined status. Having knowledge of the predefined status of the entity allows the behavioral data of the entity to be subsequently used for training the artificial neural model.

Diagram 420 illustrates data extracted from a plurality of events associated with the entity (with the Seller_id of 123456). The extracted events in diagram 420 occurred within a predefined period, for example, 60 days before the scoring date of 2019 Jul. 1 (in a year-month-date format) on which a behavior tag was associated with the entity. There may be one or more features associated with each event. The data pertaining to these features may be “flattened” or generated into an entity graph that includes relationship constraints in the manner as discussed with reference to FIG. 3.

The “flattening” process generates refined event codes. There may be one event code for each event. Diagram 420 may list several events (e.g., corresponding to event codes 22, 26, and 53) for reasons of simplicity, but it is understood that the number of events extracted during the predefined time period may be on the order of tens, hundreds, or even thousands. Each extracted event also has a corresponding event timestamp. For example, diagram 420 illustrates a timestamp of “2019-05-03 19:02:56” for the event with the event code 22, a timestamp of “2019-05-03 19:04:58” for the event with the event code 26, and a timestamp of “2019-06-30 09:17:23” for the event with the event code 53.

Diagram 430 illustrates data sequences that are generated based on the event codes and the timestamps. For example, a first data sequence may be generated by compiling together some or all the event codes obtained from diagram 420. The first data sequence of event codes may include: the event code having the value 22, the event code having the value 26, some other event codes shown as “ . . . ”, and the event code having the value 53. In some embodiments, the event codes in the first data sequence are sorted chronologically based on their respective timestamps.

Diagram 420 also illustrates a second data sequence generated as a sequence of time intervals. In more detail, each event may be spaced apart from a preceding event (or from a subsequent event) by a time interval. For example, diagram 420 illustrates a time interval of 122 seconds that separates the events with the event codes 22 and 26. In some embodiments, in the second data sequence, a default or pre-set time interval of −1 seconds (or another default or out-of-range value) may be assigned as the time interval between the first event (e.g., the event corresponding to the event code 22) and its “preceding” event. The “preceding” event may not exist or exist outside the predefined time period and is assigned a default or pre-set value.

It is understood that the first data sequence and the second data sequence in FIG. 4 are merely non-limiting examples of data sequences that may be generated based on the behavioral data of the entity. Other data sequences may also be generated based on the behavioral data of the entity or behaviors of other entities. For example, a third data sequence may be generated as a sequence of true or false flags with respect to whether the event was triggered by the entity itself. In that regard, for each corresponding event in the data sequence, the true or false flag may be set to a value of 1 (representing true) if the event was triggered by the entity (e.g., the entity initiated a log out of the account), and the true or false flag may be set to a value of 0 (representing false) if the event was triggered by someone other than the entity (e.g., the electronic transaction platform logged the entity out of its account). For reasons of simplicity, these additional data sequences are not discussed in detail herein.

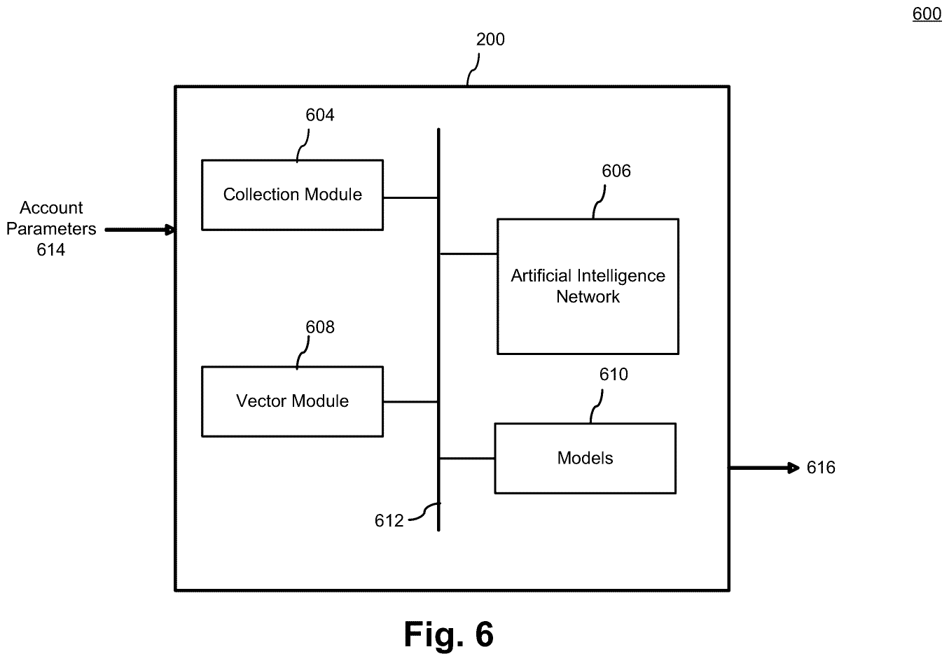

The first data sequence (e.g., comprising event codes) and the second data sequence (e.g., comprising time intervals) may be training data that trains machine learning module 440 or parts of the machine learning module 440. Machine learning module 440 may be machine learning module 200 discussed in FIG. 2. The machine learning module 440 may include an ensemble of machine learning models. In some embodiments, the ensemble of machine learning models may include a GNN model, an auto encoder model, and an RNN model, the details of which will be discussed below with reference to FIG. 6. In some embodiments, the RNN model may be an LSTM model. As discussed above, the ensemble of machine learning models may be suited for sequential data, such as the first data sequence and the second data sequence. It is understood that the ensemble model training may involve the data sequences generated from not just one entity, but a plurality of entities, where each entity has already had a predefined status determined (e.g., being tagged with fraud or not being tagged with fraud, being tagged as a high value entity or not being tagged as high value entity).

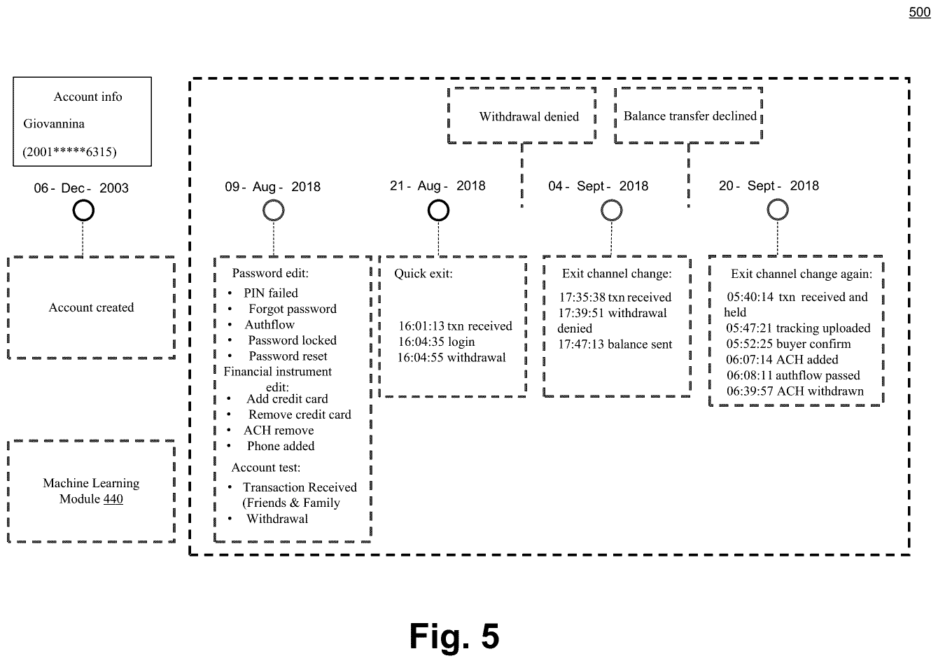

FIG. 5 is a diagram 500 that illustrates sequence of events associated with an entity, according to some embodiments. The sequence of events associated with an entity may be processed using a pre-processor as discussed above to be used an input to one or more models.

The entity in FIG. 5 a merchant named Giovannina associated with an account number “2001*****6315.” For purposes of FIG. 5, Giovannina may be an entity. In FIG. 5, a first event associated with Giovannina occurred on 6 Dec. 2003 (in a day-month-year format), which is an account creation event.

FIG. 5 illustrates that a plurality of events associated with the entity occurred on 9 Aug. 2018. Some of these events are associated with a password edit. These events may include: a failed PIN (personal identification number), a forgotten password request, an authentication flow performed to authenticate the user, a locking of the password, and a reset of the password. Some other events are associated with a financial instrument edit. These other events may include an addition of a credit card, a removal of another credit card, a removal of an ACH, and an addition of a telephone number. Yet some other events are associated with an account test. These events may include: a transaction that is received and a transaction type (e.g., friends and family), and a fund withdrawal.

FIG. 5 also illustrates that a plurality of events associated with the entity occurred on 21 Aug. 2018. These events relate to a quick exit. A quick exit may be defined as the entity quickly (e.g., within a predefined amount time) transferring a monetary balance from one of the entity's accounts (e.g., the account tied to the electronic transaction platform) to another financial instrument of the entity. The events associated with the quick exit may include a timestamp, such as “16:01:13” that corresponds to a transaction being received from the entity, a time of “16:04:35” that corresponds to the entity logging in, and a timestamp of “16:04:55” that correspond to the funds being withdrawn from the entity's account.

FIG. 5 also illustrates that a plurality of events associated with the entity occurred on 4 Sep. 2018. These events relate to an exit channel change. These events may include a timestamp of “17:35:38” that corresponds to a transaction being received from the entity, a timestamp of “17:39:51” that corresponds to a withdrawal of funds being denied, and a timestamp of “17:47:13” that corresponds to a request being made by the entity to send a balance to another financial instrument of the entity.

FIG. 5 illustrates that a plurality of other events associated with the entity occurred on 20 Sep. 2018. These events relate to a second exit channel change. These events may include a timestamp of “05:40:14” that corresponds to a transaction being received and held, a timestamp of “05:47:21” that corresponds to a tracking information for the transaction being uploaded, a timestamp of “05:52:25” that corresponds to a confirmation of the transaction being received from a buyer of the transaction, a timestamp of “06:07:14” that corresponds to an ACH being added, a timestamp of “06:08:11” that corresponds to an authentication flow of the entity being passed, and a timestamp of “06:39:57” that corresponds to the time ACH was withdrawn.

The events illustrated in FIG. 5 and discussed above are initiated or triggered by the entity, e.g., “Giovannina.”. Other events may be triggered by the electronic transaction platform. For example, between 21 Aug. 2018 and 4 Sep. 2018, the electronic transaction platform has denied a withdrawal attempt of the entity (e.g., the withdrawal made by the entity at “16:04:55” on 21 Aug. 2018). Between 4 Sep. 2018 and 20 Sep. 2018, the electronic transaction platform may deny the request from the entity to send the balance (e.g., the request made by the entity at “17:47:13” on 4 Sep. 2018). Although the events may not be triggered by the entity, they are still considered a part of the entity's behavioral data, which is used by the machine learning module 200 discussed in FIG. 1.

The events in FIG. 5 may have one or more features associated with them. The features may be compressed into the respective event by the “flattening” process discussed above. The “flattening” process generates a sequence of event codes and a sequence of time intervals between the events. The sequences may contain behavioral information regarding the behavioral history of the entity. The behavioral information may be embedded in the event codes. For example, the behavioral information embedded in the data sequences may indicates a static aspect of the behavioral history, such as: the entity has had a long history of the account (e.g., account created longer than a predefined time period), the entity had multiple transactions (e.g., the account has been used for a certain number of transactions over a certain time period), and the entity has a completed profile. The behavioral information embedded in the sequences may also indicate a dynamic aspect of the behavioral history, such as: the entity reactivated an account that has been dormant for a more than a predefined time period (e.g., the account has been dormant from 2003 to 2018), the entity kept changing its profile, and the entity's reaction to being examined by risk policies. These sequences are then sent to the artificial intelligence framework in machine learning module 200 as inputs. During the inference stage, the machine learning module 200 may generate an output. The output may be a label with a predefined status, such as fraud, prime member, and the like.

FIG. 6 is a block diagram 600 of a machine learning module implemented using hardware, according to some embodiments. As shown, machine learning module 200 includes a collection module 604, an artificial intelligence network 606, a vector module 608, and one or more modes 610, among other possible modules.

In some embodiments, collection module 604, artificial intelligence network 606, vector module 608, and one or more models 610 may take the form of one or more hardware components, such as a processor, an application specific integrated circuit (ASIC), a programmable system-on-chip (SOC), a field-programmable gate array (FPGA), and/or programmable logic devices (PLDs), a neuromorphic processor among other possibilities. As shown, collection module 604, artificial intelligence network 606, vector module 608, and one or more models 610 may be coupled to a bus, network, or other connection 612. Further, additional module components may also be coupled to the bus, network, or other connection 612. Yet, it should be noted that any two or more of collection module 604, artificial intelligence network 606, vector module 608, and one or more models 610 may be combined to take the form of a single hardware component, such as the programmable SOC. In some embodiments, the machine learning module 200 may also include a non-transitory memory configured to store instructions. Yet further the machine learning module 200 may include one or more hardware processors coupled to the non-transitory memory and configured to read the instructions to cause machine learning module 200 to perform operations described herein.

In some embodiments, collection module 604 may receive or collect account parameters 614 from one or more data sources. The account parameters 614 may indicate the behavior of an entity, a user, or a platform, such as behaviors discussed in FIGS. 3-5. The one or more data sources may include one or more databases and/or data servers in communication with machine learning module 200 discussed in FIG. 1 and that may store account parameters 614 discussed in FIGS. 3-5. Collection module 604 may collect the account parameters 614 by accessing one or more data sources (not shown).

Vector module 608 may receive account parameters 614 and determine one or more feature vectors that represent the learned user behaviors. For example, the vector module 608 may determine the entity graph discussed in FIG. 3, determine an entity embedding, and determine a sequence of parameters that may be associated with entity status discussed in FIG. 5.

Machine learning module 200 may include one or more models 610 that correspond to the learned user behaviors. The one or more models 610 may be a GNN model, an auto encoder model and an RNN model (such as an LSTM). An example of one or more models 610 may be a contact model used to predict a status of a user based on the account parameters. The status may include a fraudulent status or status associated with a high value entity. The fraudulent status may indicate an entity gaining unauthorized accesses to one or more accounts, selling counterfeit goods, or performing unauthorized transactions, fund transfers, exchanges of funds, collections of funds, and the like.

Another example of the one or more models 610 may be a detection model. The detection model may be configured to detect fraudulent actions by the one or more users.

In some embodiments, the artificial intelligence network 606 may be implemented using one or more models 610. Artificial intelligence network 606 may include or access one or more models 610 that may operate sequentially or in parallel. Alternatively, artificial intelligence network 606 may include multiple layers, such as an input layer, a hidden layer, and/or an output layer. The one or more models 610 may be included as one of the layers. In some instances, artificial intelligence network 606 may receive and transfer the collected account parameters 614 from the input layer to the hidden layer and ultimately to an output layer. For example, artificial intelligence network 606 may receive account parameters 614 and convert the account parameters 614 to hidden data by transferring the account parameters 614 from the input layer to the hidden layer. Artificial intelligence network 606 may then convert and transfer the hidden data from the hidden layer to the output layer. Artificial intelligence network 606 may convert the data in the output layer and output the data as output 616.

During the training stage, machine learning module 200 may learn to predict various users' behaviors and entity statuses from account parameters 614. Specifically, machine learning module may train artificial intelligence network 606 and models 610 via a series of training iterations using collected account parameters 614 with known user behaviors and/or entity statuses. Machine learning module 200 may customize the training iterations with the account parameters 614 based on various factors, such as the various models included in machine learning module 200.

The training of the layers of the artificial intelligence network 606 and/or models 610 may unravel the low-dimensional manifolds in the dataset and codify this data in the artificial intelligence network 606. These layers and the training of weights and biases in the one or more models 610 may be used to determine manifolds hidden in the data. The training may also determine an embedding function or functions that relate features in the input data (e.g., account parameters 614) to features in the output data (output 616). The training stage may complete when artificial intelligence network 606 and/or models 610 may encode the relationship between input and output data in the hidden layers.

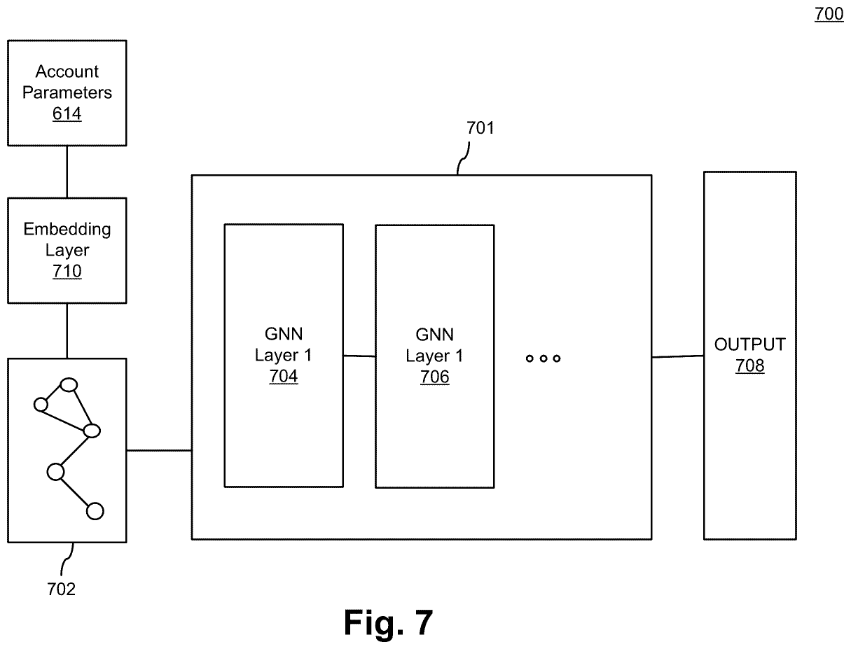

FIG. 7 illustrates an example diagram 700 of a graphical neural network (GNN), according to an embodiment. A GNN 701 depicted in FIG. 7 may be a model or a layer of artificial intelligence network 606 discussed in FIG. 6. GNN 701 may also be the first machine learning model discussed above. GNN 701 may be a deep learning network that performs inference on data described by graphs, such as an entity graph discussed in FIG. 3. GNN 701 may include one or more GNN layers, such as GNN layers 704 and 706, and so forth. The first layer, such as GNN layer 704 may receive entity graph 702. The last GNN layer (not shown) may produce an output 708 after processing entity graph 702 through the GNN 701.

In some embodiments, the input to GNN 701 may be an entity graph 702, such as an entity graph 300 discussed in FIG. 3. Entity graph 702 may be generated via a pre-processing layer 710 or an adapter layer (not shown). In some embodiments, a layer in GNN 701 may include the pre-processing layer 710 as a sub-layer (not shown). The pre-processing layer 710 may generate entity graph 702. Pre-processing layer 710 may generate entity graph 702 from a set of parameters selected from the account parameters 614. Pre-processing layer 710 may detect links between different entities across vast amounts of data. For example, the account parameters 614 may include information such as the IP, computer ID, address, phone, and the like. The account parameters 614 may be selected to uniquely identify the account. The entity graph 702 may be generated for an entity account, such as the merchant account during the onboarding of the entity. The entity graph 702 may be an input into the GNN 701. The GNN 701 may use the entity graph 702 to determine whether the account or the entity exhibits a pre-determined behavior.

Graphs, such as an entity graph 702, are a type of data structure which models a set of objects (which may be represented as nodes) and their relationships (which may be represented as edges). Entity graph 702, which may be described as a graph G that includes a set of vertices V and a set of edges E. Edges in the set of edger E may be either directional or nondirectional edges depending on whether there exist directional dependencies between vertices in the set of vertices V.

There are several benefits to using GNN 701. First, entity graph 702 may indicate constraints on relationships between the nodes. This reduces the number of account parameters 614 to a subset of parameters included in entity graph 702. As a result, GNN 701 that receives entity graphs 702 may receive and process a subset of account parameters included in entity graph 702. This, in turn, reduces the memory resources and the processing power that are used to train GNN 701 during the training stage and to run GNN 701 during the inference stage. Second, GNN 701 may be trained in real-time or at predefined time intervals on information associated with new entities included in the new entity graphs. Because the new entity graphs also constrain the number of new account parameters, GNN 701 may be updated with fewer memory and computing resources as compared to conventional methods. This is particularly beneficial when account parameters 614 include large, frequently changing, data sets.

During the training stage, GNN 701 may learn to classify nodes in graph G. In graph G, each node is naturally defined by its features and the related nodes. For example, each node v is characterized by its feature xᵥ and is associated with a ground-truth label tᵥ. During the training stage, the goal is to leverage the partially labeled graph G to predict the labels of the unlabeled nodes. GNN 701 learns to represent each node with a d dimensional vector (state) hᵥ which contains information of the node's neighborhood.

The target of the GNN 701 is to learn a state embedding hᵥ∈R^{S} which contains the information of the neighborhood and itself for each node v. The state embedding hᵥ may be an s-dimension vector of node v and may be used to produce an output oᵥ which is a distribution of the predicted node label. The computation steps for determining hᵥ and oᵥ are defined as follows:

hᵥ=ƒ(xᵥ,x_{co[v]},hᵥ_{ᵥ},x_{N}_{_{V}}) Equation (3)

oᵥ=g(hᵥ,xᵥ) Equation (4)

where xᵥ is a vector the features of node v, x_{co[v]} is a vector of the features of node v's edges, hᵥ_{ᵥ} is a vector of the states and x_{N}_{ᵥ} is a vector of the features of the nodes in the neighborhood of v. Function ƒ may be a parametric function called a local transition function. Function ƒ may be shared among all nodes and may update the node state according to vectors xᵥ, x_{co[v]}, hᵥ_{ᵥ}, x_{N}_{ᵥ}. Function g is the local output function that describes how output oᵥ is generated. Note that functions ƒ and g may be interpreted as the feedforward neural networks. In some embodiments, matrices H, O, X, and X_{N} may be constructed by stacking all the states, all the outputs, all the features, and all the node features in graph G. This may be represented as follows:

H=F(H,X) Equation (5)

0=G(H,X_{N}) Equation (6)

where function F is the global transition function and function G is the global output function. Functions F and G are stacked versions of functions ƒ and g for all nodes in graph G, respectively. The value of matrix H is the fixed point of Eq. (5) and is uniquely defined with the assumption that F is a contraction map.

Using the Banach's fixed point theorem, GNN 701 may compute the state t+1 of matrix H, shown as H^{t+1}, as follows:

H^{t+1}=F(H^{t},X) Equation (7)

Where H^{t} denotes the t^{th} iteration of matrix H and t+1 denotes the next iteration. The system described in Equations (7) may converge exponentially to the solution of Equation (5) for any initial value H(0).

In some embodiments, GNN 701 may be trained to encode an embedding function that demarcates the boundary between the entity graphs that exhibits a first pre-determined behavior and entity graphs that do not exhibit the first pre-determined behavior. For example, during the inference stage, GNN 701 may generate output 708 via a classifier layer. Output 708 may be a probability associated with various accounts. For example, output 708 may include a probability that an account is a high value account that may engage in high value transactions.

GNN 701 may be trained based on a training dataset that includes entity graphs that exhibit the first pre-determined behavior and entity graphs that do not exhibit the first pre-determined behavior. The trained GNN 701 may generate a probability associated with the pre-determined behavior. The trained GNN 701 may then determine that an account exhibits the first pre-determined behavior based on the probability. For example, GNN 701 may generate output 708 that may be a probability that a high value account may engage in high value transactions. The training may be described as demarcating a first decision boundary associated with GNN 701 based on the first training graph and the second training graph, the first decision boundary delineating the boundary between entities that exhibit the first pre-determined behavior and entities that do not exhibit the first pre-determined behavior. The trained GNN 701 may determine that the first account exhibits the first pre-determined behavior based on a position of the first entity graph in GNN 701 relative to the first decision boundary. The training may be viewed as unraveling the manifold in the dataset to demarcate the boundary between features that exhibit the first pre-determined behavior and entities that do not exhibit the first pre-determined behavior.

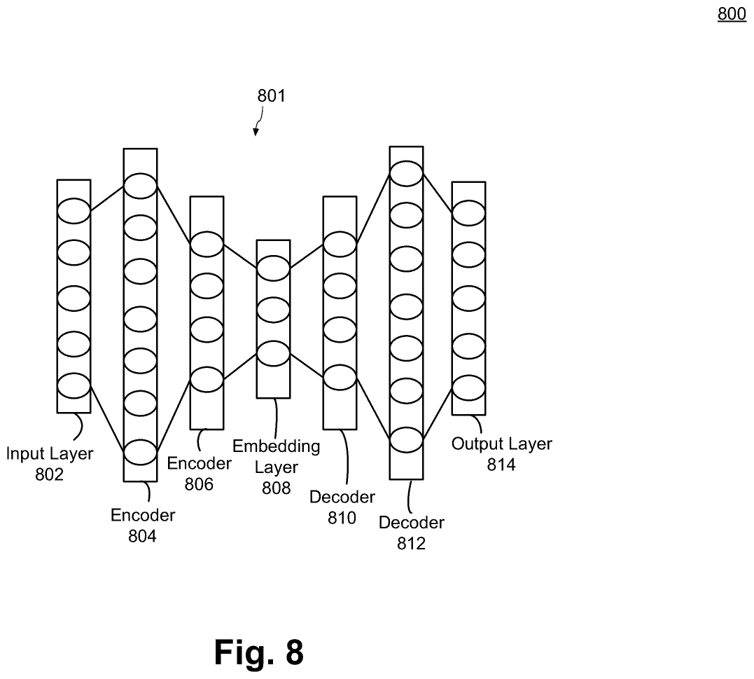

FIG. 8 is a block diagram 800 of an auto encoder, according to some embodiments. An auto encoder 801 depicted in FIG. 8 may be a model or a layer of artificial intelligence network 606 discussed in FIG. 6. Auto encoder 801 may also be the second machine learning model discussed above. The auto encoder 801 may include an input layer 802, an encoder 804, an encoder 806, an embedding Z, a decoder 810, a decoder 812, and an output layer 814. Input layer 802 receives input X and output layer 814 produces an output X′. Auto encoder 801 is designed to convert the input X received at the input layer 802 into a vector embedding and then convert the vector embedding into an output X′ in the output layer 812. Output X′ is a reconstructed input X. Auto encoder 801 is trained to identify manifolds (e.g., the embedding 808) in the input X that are of a lower-dimension than the input X. The auto encoder 801 may then reconstruct the input X as output X′ from the identified manifold at the output layer 814.

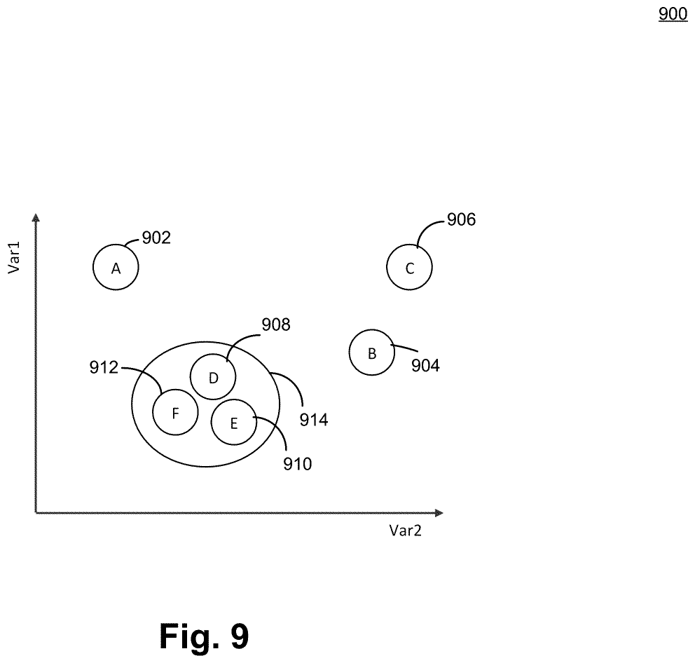

Additionally, the auto encoder 801 may also output an embedding Z at an embedding layer 808. Embedding layer 808 may be a pre-processing layer. The embedding Z is an n-dimensional vector embedding that is smaller than the input X. The auto encoder 801 may determine the n-dimensional vector embedding for multiple entities. The n-dimensional vector embeddings may be present in an n-dimensional space as described with reference to FIG. 9 below.

Auto encoder 801 may be a manifold learning or a multimodal auto encoder. Auto encoder 801 may reduce the dimensions of the account parameters associated with the account, such as account parameters 614 discussed above. For example, the service provider may have multiple accounts that have different account parameters. In another example, the pre-embedding dataset may include account parameters that are relevant to the pre-determined behavior. For example, the service provider account portfolio may have generic account parameters that may be included in each account. Examples of these account parameters may include a name of the account holder, geography, internet protocol (IP) address, related entities, financial information, product usage and the like. The account parameters may be input X received by the input layer 802.

Auto encoder 801 may be trained to create an n-dimensional vector space associated with the service provider accounts. The n-dimensional vector space may be less than the m-dimensions associated with the service provider account parameters, where m corresponds to the number of dimensions of the input X. During the inference stage, auto encoder 801 may convert the input X into the embedded account vectors. The n-dimensional vector space may analyze the user behavior by analyzing the distance between these embedded account vectors associated with the accounts. The vector distance represents the correlation and/or similarity between two or more vectors. If an account vector is very close to another account vector in the vector space, there is a high probability the two accounts are linked together.

Auto encoder 801 may use an unsupervised learning technique in which a deep neural network is trained to reproduce input X based on the reconstruction error between input data X and the output X′ at the output layer 814. The reconstruction error may be based on the error function, which may a squared reconstruction error. Auto encoder 801 may be trained to optimize the reconstruction error function as follows:

L(X,X′)=|X−X′|² Equation (8)

Auto encoder 801 may use encoder 804 (or encoder 804 and encoder 806) to encode input X 802 (e.g., account parameters 614) into embedding Z using embedding layer 808. An embedding may be a representation of the data in a compressed format. Encoder 804 may transform input X at the input layer 802 into an embedding. Input X may be represented as X∈R^{D} and embedding Z may be represented as Z∈R^{K}, where K and D are integers, such that K<<D. To generate embedding Z, encoder 804 may use a single neural network layer, as follows:

Z=α(WₑX+bₑ) Equation (9)

where Wₑ is a matrix of linear weights, bₑ is bias, and a may be a non-linear activation function, such as a Rectified Linear Unit (ReLU).

Decoder 810 (or decoder 810 and 812) may decode embeddings Z into output X′ at the output layer 814. For example, decoder 810 may reconstruct output X′ at the output layer 814 from embeddings Z at the embedding layer 808 as follows:

X′=α(W_{d}Z+b_{d}) Equation (10)

where W_{d} is a matrix of linear weights, b_{d} is bias, and a may be a non-linear activation function, such as a ReLU, which may be the same or different ReLU that is associated with encoder 804.

In some embodiments, a regularization technique may be used to tie the weights of the encoder (e.g., 804, 806) and decoder (e.g., 810, 812), such that W_{d}=Wₑ^{T}. In some instances, encoder 804 may be a single layer encoder with no activation function and mean squared error (MSE) loss. In this case, auto encoder 801 may behave like a principal compound analysis learning algorithm, learning to project the input in the span of the first K principle components of the data. However, in a multi-layer encoder 804 and/or 806, with multiple hidden layers and non-linear activation functions at each layer, the embedding Z may encode complex higher-level features. Thus, the embedding Z may capture conceptual information about the input data X.

FIG. 9 is a diagram 900 illustrating a vector space generated using the auto encoder of FIG. 8, according to some embodiments. FIG. 9 illustrates entities A 902, B 904, C 906, D 908, and E 910 in a two dimensional space. Var 1 and var 2 represent the dimensions. A person of skill in the art will understand that this is merely a two dimensional representation for ease of explanation and this explanation extrapolates to an n-dimensional space. As illustrated in FIG. 9, entities F 912, D 908 and E 910 may exhibit the pre-determined behavior because entities F912, D 908, and E 910 are within close proximity to each other shown as being within the same circle 914. Entities A 902, B 904 and C 906, however, are less likely to exhibit the pre-determined behavior because they are not located in proximity to each other. The auto encoder 801 may determine an m-dimensional vector space based on the n-dimensional vector space of the entity. The n-dimensional vector space may be based on the account parameters 614 of the entity. The embedding of the entities that exhibit the second pre-determined behavior may be determined using auto encoder 801 being fed account parameters 614 of the first entity, as input data X Similarly, embedding of the entities that do not exhibit the second pre-determined behavior may be determined based the auto encoder 801 being fed the account parameters 614 of the second entity.

Auto encoder 801 may determine whether the account exhibits a pre-determined behavior based on the vector distance associated with an embedding of the account being within the vector proximity threshold to another account with known behavior. During the inference stage, the entity features, such as account parameters 614 of the new entity (e.g. entity 908), may be fed as input X to the input layer 802 of auto encoder 801 to obtain the embedding associated with the new entity. The vector distance between embedding that exhibit the second pre-determined behavior (e.g., embeddings of entities 910 and 912) and an embedding of the new entity (e.g., embedding of entity 908) may be determined. Based on the vector distance being within a proximity threshold (e.g., vector distance between embeddings of entities 910 and 908 and/or embeddings of entities 912 and 908), auto encoder 801 may determine that the new entity (entity 908) exhibits the second pre-determined behavior (e.g., behavior of entities 910 and/or 912).

In another example, the auto encoder 801 may determine that an embedding of the newly entity account that was onboarded may be linked or proximate in the m-dimensional vector space to other historical accounts in the m-dimensional vector space. The auto encoder 801 may then determine the new account as having a high probability of being linked to the second entity account and may also exhibit similar behavior as the second account.

In some embodiments, the proximity threshold may be a boundary between entities that are likely to share the same pre-determined behavior. A proximity threshold may be based on the computing resources such that the there is a tradeoff between the computing resources and the granularity between the demarcation. In FIG. 9, for example, entities 908, 910, and 912 are within the proximity threshold from each other.

Similarly, the vector distance between the embedding of an entity that exhibits the second pre-determined behavior and the embedding of the new entity may be determined. For example, the auto encoder 801 may determine that the embedding of the new entity account that was onboarded may be linked to or proximate in the m-dimensional vector space to other historical accounts in the m-dimensional vector space. The auto encoder 801 may then determine the new account as having a high probability of being linked to a historical account of the entity and may also exhibit similar behavior as the historical account.

In an example where artificial intelligence network 601 includes multiple models, auto encoder 801 may receive account parameters 614 for entities that artificial intelligence network 601 already determined to exhibit the pre-determined behavior. Determining the entity embedding 808 for entities that already exhibit the predetermined behavior (and not for entities that do and do not exhibit the predetermined behavior) reduces the computing resources, such as memory and processor resources during training and inference stages. In addition, determining entity embeddings for fewer entities that exhibit certain type of predetermined behavior reduces the computing time required for processing a large number of entities. Finally, determining the embedding for those entities reduces the number of parameters in auto encoder 801 and the time required for gradient descent during the training stage of auto encoder 801. This allows for determining a finer grained embedding function that demarcates the boundary between entities that exhibit the pre-determined behavior and the entities that do not, while using fewer computing resources.

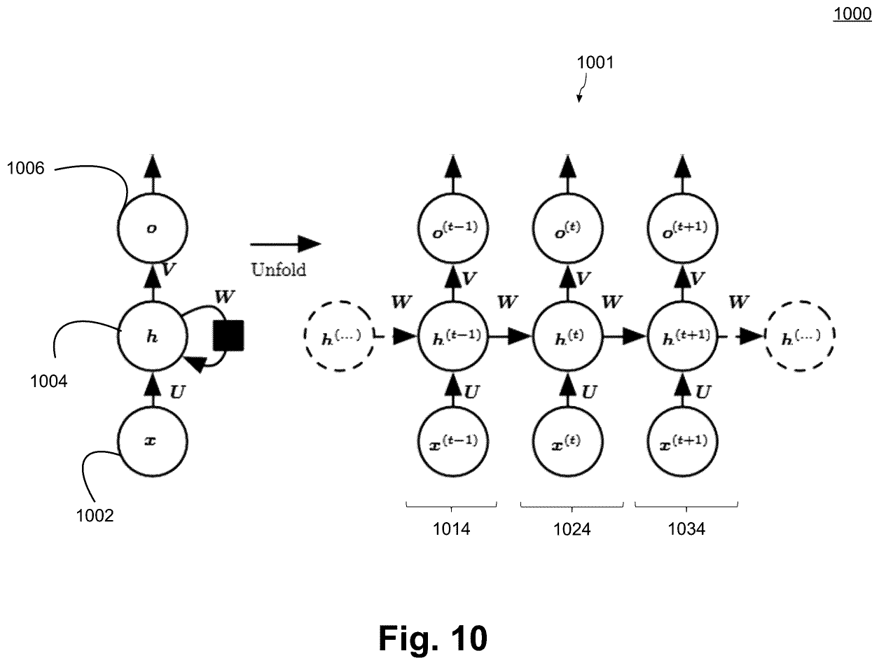

FIG. 10 is a block diagram 1000 of a recurrent neural network (RNN), according to some embodiments. An RNN 1001 depicted in FIG. 10 may be a model or a layer of artificial intelligence network 606 discussed in FIG. 6. RNN 1001 may also be the third machine learning model discussed above. The RNN 1001 may include an input layer 1002, a hidden layer 1004, and an output layer 1006. RNN 1001 may receive a sequence of data, such as a sequence from a set of the account parameters 614 at an input layer 1002.

RNN 1001 may be computationally visualized as an unraveled network shown as iterations 1014, 1024, and/or 1034. Iterations 1014, 1024, and/or 1034 may be computed in the RNN 1001 at different times. For example, iteration 1014 may be computed at time t, iteration 1024 may be computed at time t+1, and iteration 1034 may be computed at time t+2. In an alternative embodiment, iterations 1014, 1024, and/or 1034 may be computed substantially simultaneously.

RNN 1001 may address issues with a feed-forward neural network where information moves in one direction from the input layer, through the hidden layers, to the output layer. RNN 1001 may have a memory of the inputs it received during previous iteration(s). RNN 1001 may also have the order in time of a sequence. RNN 1001 may predict the next feature in a sequence of characters. In RNN 1001, the information cycles through a loop. The output of RNN 1001 is based on the current input and also based on the learned memory from the hidden inputs it received previously.

In some embodiments, RNN 1001 may receive input, designated as input x(t), at time t. The input x(1) at time t=1 may be a one-hot vector corresponding to a word of a sentence. During the training stage, the RNN 1001 may determine a hidden state h(t) at time t which act as “memory” of the RNN 1001. The hidden state h(t) may be determined based on the current input and the hidden state h at a previous time, such as time t−1, as follows:

h(t)=ƒ(U x(t)+W h(t−1)) Equation (11)

where the function ƒ may be a non-linear transformation such as tanh, or ReLU, and U W are weighted matrices. During training, the input layer 1002 and the hidden layer 1004 of the RNN 1001 are parametrized by a weight matrix U, hidden-to-hidden recurrent connections parameterized by a weight matrix W, and hidden-to-output connections parameterized by a weight matrix V. The weights (U,V,W) may be shared across time, e.g., t=0 . . . n, where n is an integer. The output, designated as o(t) is the output from output layer 1006 of the RNN 1001. In the FIG. 10, the arrow after o(t) indicates further neural network layers downstream from RNN 1001.

The RNN 1001 may be trained using a backpropagation algorithm through time and gradient descent. Backpropagation may be used for calculating the gradient of an error function with respect to the weights of RNN 1001. The backpropagation algorithm works its way backwards through the various layers of RNN 1001 to find gradients that are the partial derivative of the errors with respect to the weights. The backpropagation algorithm then updates the weights to decrease error margins during the next iteration of the training stage. The back propagation through time refers to performing backpropagation on an unrolled RNN 1001.

In some embodiments, the forward pass through RNN 1001 may be represented as follows:

a^{(t)}=b+Wh^{(t-1)}+Ux^{(t)} Equation (12)

h^{(t)}=tanh(a^{(t)}) Equation (13)

o^{(t)}=c+Vh^{(t)} Equation (14)

ŷ^{(t)}=softmax(o^{(t)}) Equation (15)

where b parameters are the bias vectors, and weight matrices U, V and W are for input-to-hidden, hidden-to-output and hidden-to-hidden connections respectively. The Equations (12)-(13) are associated with RNN 1001 that maps an input sequence to an output sequence of the same length. RNN 1001 may also map one input to one output, one input to many outputs, many inputs to one output or many inputs to many outputs.

As discussed above, RNN 1001 may be the third machine learning model. RNN 1001 may receive a sequence of the account parameters 614. The sequence of account parameters 614 may include inputs over space or time. RNN 1001 may predict a category for the sequence. For example, the sequence of parameters may be events that occurred after the account was created or during the creation of the account. The RNN 1001 may then use the sequence of parameters to determine whether the entity or the account exhibits a pre-determined behavior. RNN 1001 may also determine, based on the sequence of account parameters 614, whether a customer activity during the early lifecycle of the account is similar to the sequence of early account parameters of other accounts that exhibited the pre-defined behavior. The pre-determined behavior may be a status, a behavior that is a high risk behavior, a behavior that is a high value behavior or the like.

A pre-processing layer (not shown) may determine a sequence of parameters based on account parameters 614. The pre-processing layer may be external to or be a sub-layer of the RNN 1001.

To train the RNN 1001, the dataset may include early lifecycle sequences of account parameters of various entities, such as service provider customers. The RNN 1001 may determine, via an pre-processing layer, a vector representation for each sequence of account parameters. The vector representations may correspond to different types of actions (e.g., adding a bank account). Decision boundary in RNN 1001 may demarcate a transition between an entity with a pre-determined behavior and another entity that does not exhibit the pre-determined behavior. The trained RNN 1001 may determine that an account exhibits a pre-determined behavior based on a position of the sequence of account parameters from account parameters 614 associated with an action relative to a decision boundary in RNN 1001.

In some embodiments, RNN 1001 may process account parameters at 614 of various entities at different points in time. For example, RNN 1001 may execute after a pre-determined time period after a service provider onboards a new account. RNN 1001 may analyze the sequence of events for the accounts, and then predict the next actions associated with the account based on the sequence of events. For example, RNN 1001 may predict merchant activity after a merchant creates an account. RNN 1001 may also predict whether the account has certain pre-determined behavior, such as being a high value account.

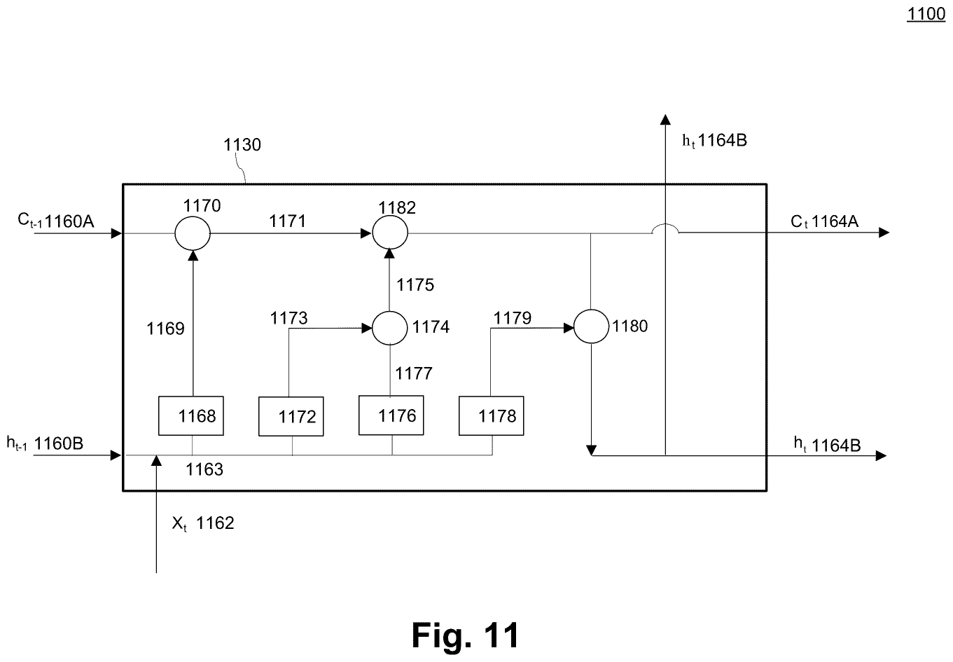

In some instances, RNN 1001 may include an LSTM network. FIG. 11 is a diagram 1100 of an LSTM network, according to some embodiments. An LSTM network may be a node 1130, which is a hidden node (e.g., node 1130) in RNN 1001 that is discussed in FIG. 10. The LSTM network may be designed to store information over multiple time periods, such as a time period that is two steps (t-2) prior to the current time period t. To remember inputs, node 1130 may include gates, such as gates 1168, 1172, 1176, and 1178. Node 1130 may receive three inputs, a previous cell state Cₜ₋₁ 1160A from a previous time period t−1, the hidden cell state 1160B from the previous time period t−1, and the input Xₜ 1162 from the current time period t.

The previous cell state Cₜ₋₁ 1160A may be a cell state of a previous iteration of the LSTM network. The previous cell state Cₜ₋₁ 1160A may be the cell state 1160A in an unrolled RNN 1001 of FIG. 10 at iteration 1014.

Node 1130 receives input Xₜ 1162. Input Xₜ 1162 may be a new input that includes a set of parameters from account parameters 614. Input Xₜ 1162 may correspond to the input at the hidden node 1130 at iteration 1024 in FIG. 10. Node 1130 receives input Xₜ 1162 via input gates 1172 and 1176, forget gate 1168 and output gate 1178. Gates 1172, 1176, 1168, and 1178 determine how node 1130 would process input Xₜ 1162. For example, node 1130 may determine whether input Xₜ 1162 should be let into node 1130, whether to delete input Xₜ 1162 because it is, e.g., not important by using the forget gate 1168, or whether input Xₜ 1162 should impact the output via the output gate 1178.

Gates 1168, 1172, 1176, and 1178 in node 1130 may be designed using an activation layer of a neural network such as a sigmoid layer. A sigmoid layer uses a sigmoid function that produces an output between 0 and 1. This means gates 1168, 1172, 1176, and 1178 may output a range of values from zero to one (or between another range of numbers). This analog property enables the gates to perform backpropagation.

Node 1130 may receive an input hₜ₋₁ 1160B. Input hₜ₋₁ 1160B may be from the previous hidden layer such as from iteration 1024 in the unrolled RNN 1001 of FIG. 10. Node 1130 may concatenate input hₜ₋₁ 1160B and the new input Xₜ 1162 into input 1163. The concatenated input 1163 may be transferred to gates 1168, 1172, and 1178, that use a sigmoid activation function and to gate 1176 that uses a tanh activation function.

Some information in the cell state is no longer needed and is erased. Forget gate 1168 may determine whether to erase the information. Forget gate 1168 may generate sigmoid output 1169. The sigmoid output 1169 from the forget gate 1168 may be determined by the function ƒₜ as follows:

ƒₜ=σ(W_{ƒ}·[hₜ₋₁,xₜ]+b_{ƒ}) Equation (16)

The forget gate 1168 receives two inputs: input Xₜ 1162 and input hₜ₋₁ 1160B that are multiplied with the relevant weight matrix W_{ƒ} before bias b_{ƒ} is added to the product. The result is sent into an activation function σ, which outputs a binary value that decides whether the sigmoid output 1169 is retained or forgotten by forget gate 1168.

Node 1130 may transfer cell state Cₜ₋₁ 1160A to a pointwise operation 1170. Further, node 1130 may determine the second cell state Ct 1164A based on the cell state Cₜ₋₁ 1160A transferred to pointwise operation 1170 and further based on one or more gates 1168, 1172, 1176, and/or 1178. In particular, the sigmoid output 1169 may be transferred to the pointwise operation 1170 with the cell state Cₜ₋₁ 1160A. The pointwise operation 1170 may perform a multiplication operation between the sigmoid output 1169 and the cell state Cₜ₋₁ 1160 to produce the operation output 1171.

The input gates 1172 and 1176 determine whether the new information, such as input 1163, may be added to the cell state Cₜ₋₁ 1160. Similarly, to forget gate 1168, input gates 1172 and 1176 receive input 1163 which includes new input Xₜ 1162 concatenated with the previous cell state input hₜ₋₁ 1160. Gates 1172 and 1176, however, include a different set of weights than the forget gate 1168. Gates 1172 may generate a sigmoid output 1173 (which may be represented as it) and gate 1176 may generate a tanh output 1177 (which may be represented as C′ₜ) as follows:

iₜ=σ(Wᵢ·[hₜ₋₁,xₜ]+bᵢ) Equation (17)

C′ₜ=tanh(W_{c}·[hₜ₋₁,xₜ]+b_{c}) Equation (18)

where W is the weight, hₜ₋₁ is the previous cell state input hₜ₋₁ 1160, xₜ is input Xₜ 1162 and b is bias.

The sigmoid output 1173 from the input gate 1172 and the tanh output 1177 from gate 1176 are transferred to the pointwise operation 1174 to produce an operation output 1175. The pointwise operation 1174 may be a multiplication operation.

A pointwise operation 1182 may receive outputs 1171 and 1175 as inputs and generate the second cell state Ct 1164A. In particular, operation 1182 may receive sigmoid output 1169 (ƒₜ), the sigmoid output 1173 (iₜ), the tanh output 1177 (C′ₜ), and the first cell state 1160A (Cₜ₋₁), to determine the second cell state Cₜ 1164A. The second cell state Ct 1164A may be determined as follows:

Cₜ=ƒₜ*Cₜ₋₁+iₜ*C′ₜ Equation (19)

The output gate 1178 receives input 1163, which includes input Xₜ 1162 concatenated with the previous cell state input hₜ₋₁ 1160. Output gate 1178 extracts meaningful information from input 1163 and generates a sigmoid output 1179. The sigmoid output 1179 from the output gate 1178 may be represented by oₜ and may be determined as follows:

oₜ=(Wₒ·[hₜ₋₁,xₜ]+bₒ) Equation (20)

where W is the weight, hₜ₋₁ is the previous cell state input hₜ₋₁ 1160, xₜ is input Xₜ 1162 and bis the bias.

The pointwise operation 1180 receives the sigmoid output 1179 and the second cell state Cₜ 1164A and generate output hₜ 1164B. Pointwise operation 1180 may be a multiplication operation. Output hₜ 1164B may be determined as follows:

hₜ=oₜ·tanh(Cₜ) Equation (21)

where hₜ is output hₜ 1164B, Cₜ is the second cell state Cₜ 1164A, and oₜ is an output from output gate 1178. The second cell state Cₜ 1164A and output hₜ 1164B may be associated with the user behaviors. As such, the user behaviors may be learned based on the output hₜ 1164B and/or the second cell state Cₜ 1164A.

The LSTM network may model the sequence of account parameters 614 that are related to entities that exhibit a pre-determined behavior. For example, assume a new account A was recently created by the service provider and a sequence of actions was performed on the website of the service provider such as on PayPal.com. The first machine learning model, such as the GNN (discussed in FIG. 7) may detect, during the onboarding process, that the account A is linked to account B by IP and Computer ID. The account parameters 614 may be the time account B joined the service provider (e.g., two years ago), whether the customer or entity is an active merchant on the platform of the service provider, and the like. The second machine learning model, such as the auto encoder (discussed in FIG. 8) may determine the embeddings of the account A in the n-dimensional vector space from account parameters 614 and may determine the proximity of the account to other accounts in the n-dimensional vector space. Based on the results of the second machine learning model, the probability that account A and account B are linked may be determined. When the second machine learning model determines that there is a high probability that account A and B are linked, the LSTM network may determine whether the account exhibits a pre-determined behavior. For example, the LSTM network, may receive account parameters 614 and determine whether the sequence of events determined from account parameters 614 is similar to another account. For example, an account A may take similar actions as account B, such as ordering a Zettle POS terminal.

Based on the previous actions of account B, the LSTM network may determine the next action that may be associated with account A. An example action may be a request for a PPWC loan. The LSTM network may then cause the service provider to offer a loan to account A before the entity such as the customer requests the loan. In addition, the information about future actions may be used to offer better rates, or even speed up the auditing phase, because account B is well-known to the service provider.

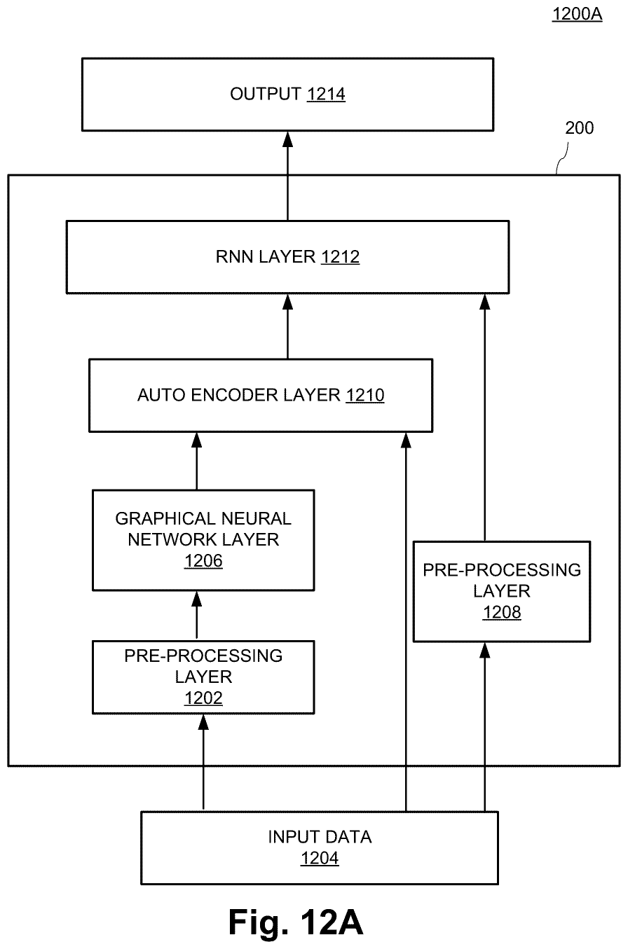

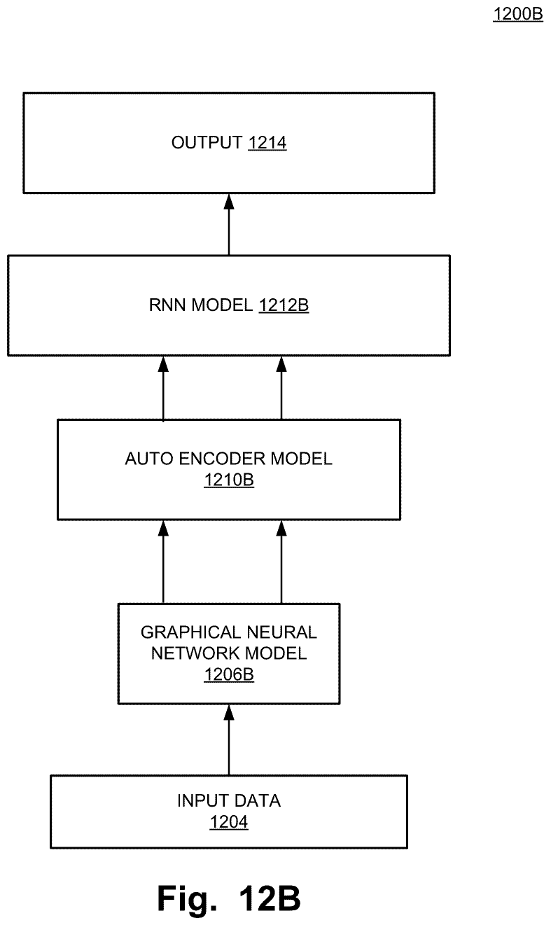

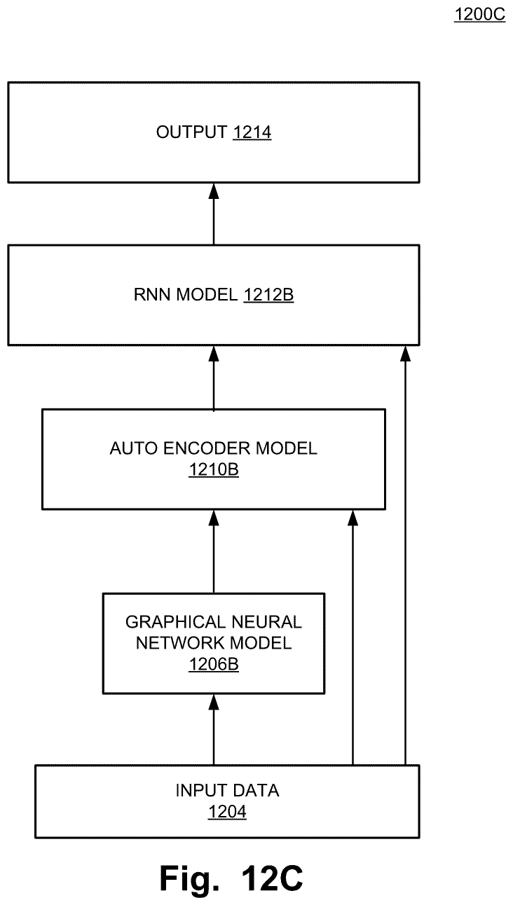

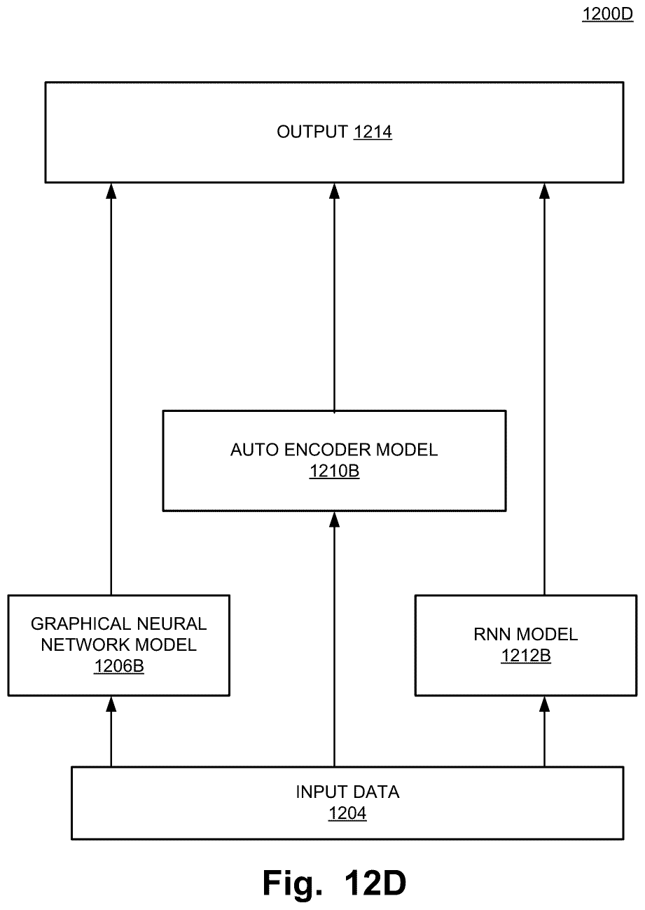

FIG. 12A is a block diagram 1200 illustrating an example machine learning module, according to some embodiments. A machine learning module 200 incorporates the various machine learning models described in FIGS. 7, 8, 10, and 11 as layers an artificial neural network. Machine learning module 200 in FIG. 12A may be the machine learning module 200 discussed in FIG. 1.

Machine learning module 200 may include a pre-processing layer 1202, a GNN layer 1206, an auto encoder layer 1210, a second pre-processing layer 1208 and an RNN layer 1212. Machine learning module 200 may receive an input data 1202 and generate an output 1214. GNN layer 1206 may be composed of the layers of the GNN described in FIG. 7. The auto encoder layer 1210 may be composed of the layers of the auto encoder described in FIG. 8. The RNN layer 1212 may to be a network described in FIGS. 10 and 11. In an example, the pre-processing layer 1202 and the pre-processing layer 1208 may be part of the other layers such as GNN layer 1206 and the RNN layer 1212 respectively or may be implemented as layers independent of GNN layer 1206 and the RNN layer 1212. In addition, the output 1214 may be produced via a classification layer (not shown) that processes the output of the RNN layer 1212.

The input data 1204 may correspond to the account parameters 614 discussed in FIG. 6. The machine learning module 200 may determine an entity graph for an entity, e.g., the merchant, using pre-processing layer 1202. The GNN layer 1206 may receive the entity graph and determine whether the entity graph is associated with a first account having a first pre-determined behavior. In response to determining the entity graph may be associated with the first account with a first pre-determined behavior, machine learning module 200 may determine an entity embeddings for the entity graph using auto encoder layer 1210. Auto encoder layer 1210 may also determine whether the entity embeddings of the account are in proximity to a second account exhibiting a second pre-determined behavior (in some instances the first account and the second account may be the same account). In response to the account exhibiting the second pre-determined behavior, the pre-processing layer 1208 may determine a sequence of events based on the account parameters 614. The RNN layer 1212 may receive an output indicating a second pre-determined behavior of the entity generated by auto encoder layer 1210 and the sequence of events generated by pre-processing layer 1208 and determine if the sequence of events is associated with a third pre-determined behavior. As discussed in FIG. 10, RNN layer 1212 may determine the third pre-determined behavior based on the similarity of the sequence of events to other events of other accounts that exhibited a similar pre-determined behavior using a similarity function. The machine learning module 200 may then generate an output 1214 indicating whether the account exhibits the pre-determined behavior based on the first pre-determined behavior, the second pre-determined behavior, the third pre-determined behavior, or a combination thereof.

FIGS. 12B, 12C, and 12D are block diagrams 1200B-1200D illustrating other examples of the machine learning module, according to various embodiments. FIGS. 12B, 12C, and 12D illustrate machine learning module 200 that includes discrete models that receive output from the other models in various permutations and combinations. The GNN model 1206B may be composed of the layers of the GNN described above with reference to FIG. 7, the auto encoder model 1210B may be composed of the layers of the auto encoder described above with reference to FIG. 8, and the RNN model 1212B may be similar to the RNN and LSTM models described above with reference to FIGS. 10 and 11.

For example, the machine learning module 200 illustrated in FIG. 12B, may receive input data 1204. The GNN model 1206B may use the input data 1204 to generate an entity vector. The entity graph represents constrained relationships between the account parameters 614. As discussed above, the constrained relationships are relationships between the nodes of the entity graph shown in FIG. 3. Constraining relationships among account parameters 614 into the entity graphs reduces the number of account parameters 614 the GNN model 1206B processes into a subset of parameters. This in turn may increase the computing efficiency of GNN model 1206B by reducing the memory usage, CPU utilization and the amount of time used to generate pre-determined behaviors for the account(s). The output of the GNN model 1206B may include a probability that account or entity associated with the entity graph exhibits a first pre-determined behavior and the input of the model 1206B for the corresponding entity. The auto encoder model 1210B may receive the output of GNN model 1206B, which may include the input data 1204 and an indication of the first pre-determined behavior, and determine embeddings associated with the account based on the account parameters 614. The auto encoder model 1210B may use the embeddings associated with the account to determine proximity to the account to other accounts which exhibit a second pre-determined behavior. The auto encoder model 1210B may output a probability that the account exhibits the second pre-determined behavior and the input data 1204. The RNN model 1212B may receive input data 1204 and determine a sequence of events based on the input data 1204.

RNN model 1212B may also determine whether the sequence of events matches an account that exhibits a third pre-determined behavior. The output 1214 of the machine learning module 200 is based on a sequence on determinations of the various models 1206B, 1210B, and 1212B. For example, in FIG. 12B the output 1214 is based on a determination of the models 1206B, 1210B, and 1212B in sequence. This reduces the parameters of the subsequent models because only the entities that exhibit a first predetermined behavior are used as inputs to the second model and only the entities that exhibit a second predetermined behavior are used as inputs to the third model.

The machine learning module 200 in FIG. 12B reduces the processing power by narrowing the entities from millions of entities at each model. This in turn decreases the inference time for determining account behavior which may be beneficial in detecting the pre-determined behavior of an account when time is of the essence. For example, detecting that an account is a fraudulent account and locking an account before fraud may occur, thus reducing potential monetary loss and the like.

FIG. 12C illustrates an alternative embodiment. The embodiment in FIG. 12C is similar to FIG. 12B where the models 1206B, 1210B and 1212B receive the output of the prior models and use a sigmoid activation function to process the entity information if the prior models indicate there is a pre-determined behavior. Such an arrangement would save computing resources and improve efficiency of computing.

Similarly, the machine learning module 200 illustrated in FIG. 12D is a parallel combination of models. The machine learning module 200 in FIG. 12D identifies the pre-determined behavior based on at least one of the models 1206B, 1210B and/or 1212B. As discussed above, the pre-determined behavior may indicate that the account is a high value account. In FIG. 12B, the output 1214 may be treated as indicating a high value account as long as one of the outputs of the models 1206B, 1210B, or 1212B predicts an entity that exhibits the high value account behavior. In an example, displaying a promotion to check for a credit card offer may be offered to an entity that may be considered high value by any of the layers because a subsequent process such as underwriting may be used to determine risk.

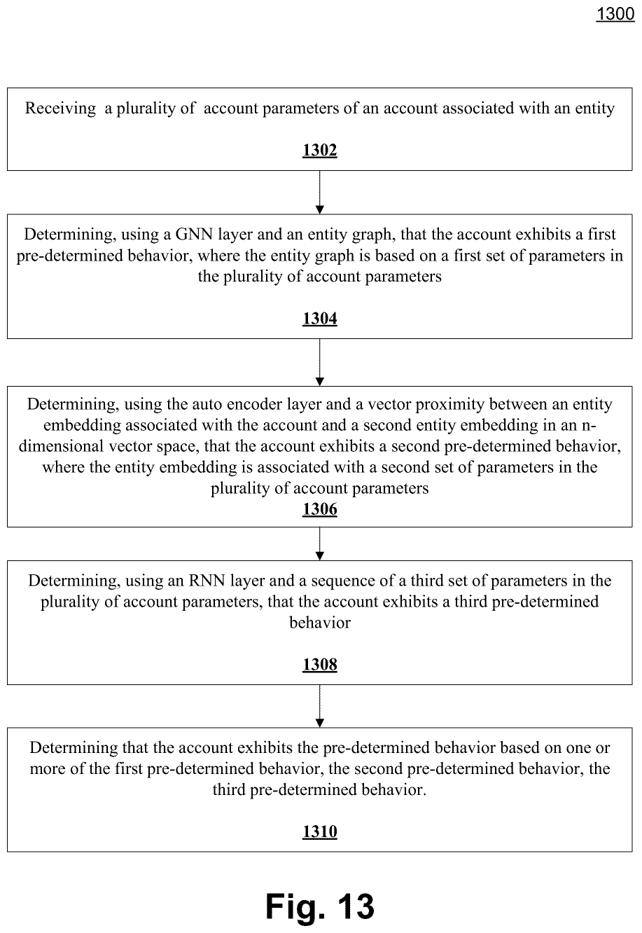

FIG. 13 is a flowchart illustrating a method 1300 for performing a machine learning process using behavioral data according to the embodiments. The various steps of the method 1300, which are described in greater detail above, may be performed by one or more electronic processors, for example by the processors of a computer associated with an entity. The entity may include a merchant, a payment provider, an operator of an electronic transaction platform, a business analyst, and the like. In some embodiments, at least some of the steps of the method 1300 may be performed by the machine learning module 200 discussed above.

At step 1302, account parameters 614 of an account associated with a first entity are received. The account parameters 614 may correspond to the transaction data of the first entity that occurred within a pre-defined time period.

At step 1304, a determination that the account exhibits a first pre-determined behavior is made. For example, the GNN layer 1206 determines that the account exhibits a first pre-determined behavior based on an entity graph. The entity graph is based on a first set of account parameters from the account parameters 614 associated with the account.

At step 1306, a determination that the account exhibits a second pre-determined behavior is made. For example, auto encoder layer 1210 determines that the account exhibits a second pre-determined behavior based a vector proximity between entity embeddings of the first entity and entity embedding of a second entity associated with other accounts in an n-dimensional vector space. The first entity embedding of the entity are based on a second set of account parameters from the account parameters associated with the account and the entity embeddings associated with other accounts that exhibits the second pre-determined behavior.

At step 1308, a determination that the account exhibits a third pre-determined behavior is made. For example, RNN layer 1212 determines that the account exhibits a third pre-determined behavior based on a sequence of a third set of parameters from the account parameters 614 associated with the account.

At step 1310, a determination that the account exhibits the pre-determined behavior based on one or more of the first pre-determined behavior, the second pre-determined behavior, the third pre-determined behavior is made.

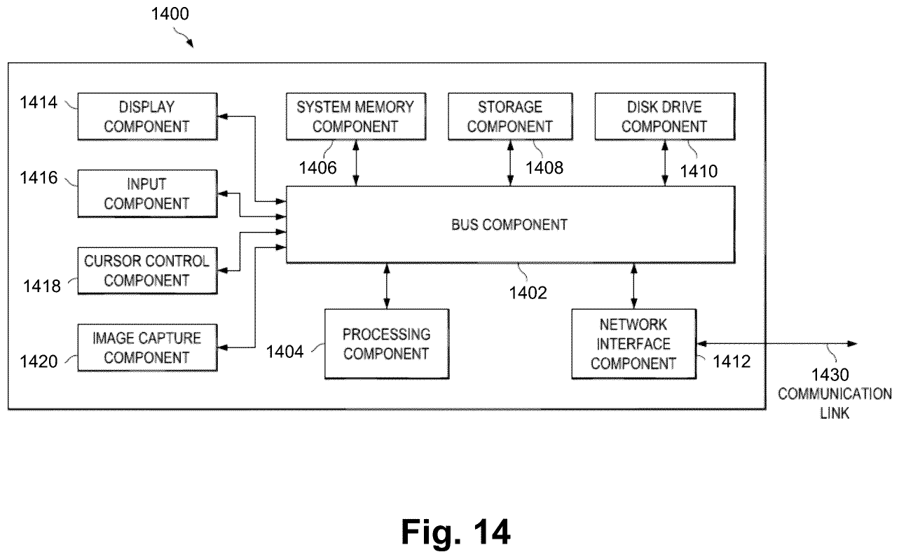

FIG. 14 is a block diagram of a computer system 1400 suitable for implementing various methods and devices described herein, for example, the machine learning module 200, the user device 110, the merchant server 140, or the payment provider server 170. In various implementations, the devices capable of performing the steps may comprise a network communications device (e.g., mobile cellular phone, laptop, personal computer, tablet, etc.), a network computing device (e.g., a network server, a computer processor, an electronic communications interface, etc.), or another suitable device. Accordingly, it should be appreciated that the devices capable of implementing the machine learning module 200 and the various method steps of the method 1300 discussed above (or the user device 110, the merchant server 140, or the payment provider server 170) may be implemented as the computer system 1400.

In accordance with various embodiments of the present disclosure, the computer system 1400, such as a network server or a mobile communications device, includes a bus component 1402 or other communication mechanisms for communicating information, which interconnects subsystems and components, such as a computer processing component 1404 (e.g., processor, micro-controller, digital signal processor (DSP), etc.), system memory component 1406 (e.g., RAM), static storage component 1408 (e.g., ROM), disk drive component 1410 (e.g., magnetic or optical), network interface component 1412 (e.g., modem or Ethernet card), display component 1414 (e.g., cathode ray tube (CRT) or liquid crystal display (LCD)), input component 1416 (e.g., keyboard), cursor control component 1418 (e.g., mouse or trackball), and image capture component 1420 (e.g., analog or digital camera). In one implementation, disk drive component 1410 may comprise a database having one or more disk drive components.

In accordance with embodiments of the present disclosure, computer system 1400 performs specific operations by the processor 1404 executing one or more sequences of one or more instructions contained in system memory component 1406. Such instructions may be read into system memory component 1406 from another computer readable medium, such as static storage component 1408 or disk drive component 1410. In other embodiments, hard-wired circuitry may be used in place of (or in combination with) software instructions to implement the present disclosure. In some embodiments, the various components of the machine learning module 200 may be in the form of software instructions that can be executed by the processor 1404 to automatically perform context-appropriate tasks on behalf of a user.

Logic may be encoded in a computer readable medium, which may refer to any medium that participates in providing instructions to the processor 1404 for execution. Such a medium may take many forms, including but not limited to, non-volatile media and volatile media. In one embodiment, the computer readable medium is non-transitory. In various implementations, non-volatile media includes optical or magnetic disks, such as disk drive component 1410, and volatile media includes dynamic memory, such as system memory component 1406. In one aspect, data and information related to execution instructions may be transmitted to computer system 1400 via a transmission media, such as in the form of acoustic or light waves, including those generated during radio wave and infrared data communications. In various implementations, transmission media may include coaxial cables, copper wire, and fiber optics, including wires that comprise bus 1402.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the machine learning module 200 discussed above.

In various embodiments of the present disclosure, execution of instruction sequences to practice the present disclosure may be performed by computer system 1400. In various other embodiments of the present disclosure, a plurality of computer systems 1400 coupled by communication link 1430 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 1400 may transmit and receive messages, data, information and instructions, including one or more programs (i.e., application code) through communication link 1430 and communication interface 1412. Received program code may be executed by computer processor 1404 as received and/or stored in disk drive component 1410 or some other non-volatile storage component for execution. The communication link 1430 and/or the communication interface 1412 may be used to conduct electronic communications between the machine learning module 200 and external devices, for example with the user device 110, with the merchant server 140, or with the payment provider server 170, depending on exactly where the machine learning module 200 is implemented.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the machine learning module 200 may be implemented as such software code.

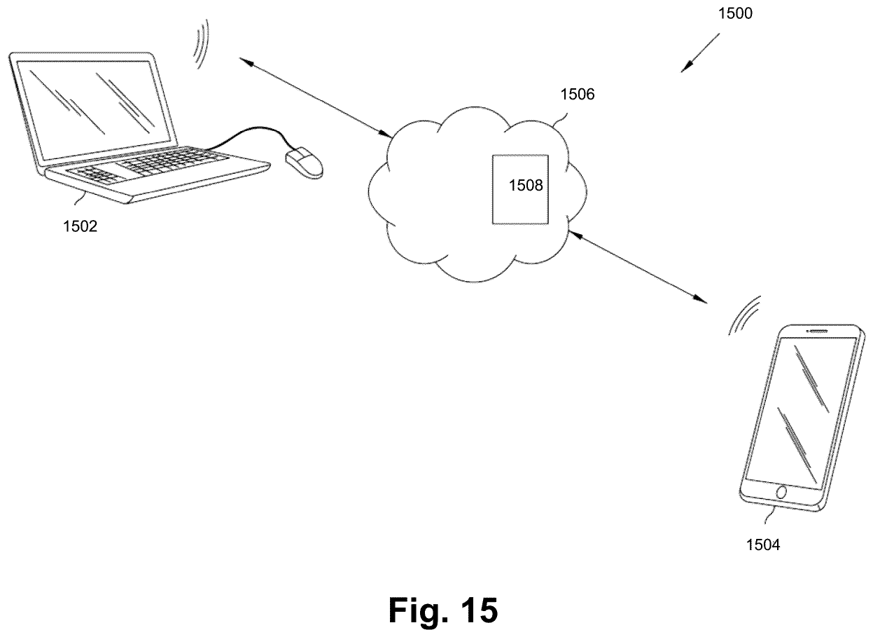

FIG. 15 illustrates an example cloud-based computing architecture 1500, which may also be used to implement various aspects of the present disclosure. The cloud-based computing architecture 1500 includes a mobile device 1504 (e.g., the user device 110 of FIG. 1) and a computer 1502 (e.g., the merchant server 140 or the payment provider server 1510), both connected to a computer network 1506 (e.g., the Internet or an intranet). In one example, a consumer has the mobile device 1504 that is in communication with cloud-based resources 1508, which may include one or more computers, such as server computers, with adequate memory resources to handle requests from a variety of users. A given embodiment may divide up the functionality between the mobile device 1504 and the cloud-based resources 1508 in any appropriate manner. For example, an app on mobile device 1504 may perform basic input/output interactions with the user, but a majority of the processing may be performed by the cloud-based resources 1508. However, other divisions of responsibility are also possible in various embodiments. In some embodiments, using this cloud architecture, the machine learning module 200 may reside on the merchant server 140 or the payment provider server 1510, but its functionalities can be accessed or utilized by the mobile device 1504, or vice versa.

The cloud-based computing architecture 1500 also includes the personal computer 1502 in communication with the cloud-based resources 1508. In one example, a participating merchant or consumer/user may access information from the cloud-based resources 1508 by logging on to a merchant account or a user account at computer 1502. The system and method for performing the machine learning as discussed above may be implemented at least in part based on the cloud-based computing architecture 1500.

It is understood that the various components of cloud-based computing architecture 1500 are shown as examples only. For instance, a given user may access the cloud-based resources 1508 by a number of devices, not all of the devices being mobile devices. Similarly, a merchant or another user may access the cloud-based resources 1508 from any number of suitable mobile or non-mobile devices. Furthermore, the cloud-based resources 1508 may accommodate many merchants and users in various embodiments.

Based on the above discussions, systems and methods described in the present disclosure offer several significant advantages over conventional methods and systems. It is understood, however, that not all advantages are necessarily discussed in detail herein, different embodiments may offer different advantages, and that no particular advantage is required for all embodiments. One advantage is improved functionality of a computer. For example, conventional computer systems, even with the benefit of machine learning, have not been able to utilize an account parameter to determine the presence of a predefined behavior status or condition. This is because conventional systems have not been able to process the large amount of data while minimizing the computing resources and memory while processing the account parameters which is made possible by using the ensemble of models. The ensemble of models that includes a graphical neural network, an auto encoder and an RNN/LSTM machine learning models provide the ability to quickly determine whether a pre-determined behavior exists while minimizing the computing resources such as memory and CPU. The disclosure makes this possible by generating various types of data sequences corresponding to a user's behavioral data, which is then used to train the RNN or LSTM model. The trained model can then be used to determine a condition or status of another user with enhanced accuracy and speed compared to conventional systems.

The inventive ideas of the present disclosure are also integrated into a practical application, for example into the machine learning module 200 discussed above. Such a practical application can generate an output (e.g., a determination of fraud) that is easily understood by a human user, and it is useful in many contexts.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
receiving, via an interface, a plurality of first account parameters of a first account associated with a first entity;
determining, using an ensemble of machine learning models that the first account exhibits a pre-determined behavior, the ensemble of machine learning models comprising a first machine learning model, and a second machine learning model, wherein the determining comprises:
determining, using the first machine learning model and a first entity graph, that the first account exhibits a first pre-determined behavior, wherein the first entity graph is based on a first set of parameters in the plurality of first account parameters;
determining, using the second machine learning model and a vector proximity between a first entity embedding and a second entity embedding in an n-dimensional vector space, that the first account exhibits a second pre-determined behavior, wherein the first entity embedding is based on a second set of parameters in the plurality of first account parameters and the second entity embedding is associated with a second account that exhibits the second pre-determined behavior; and
determining the first account exhibits the pre-determined behavior based on one or more of the first pre-determined behavior, the second pre-determined behavior.

2. The method of claim 1, wherein determining using the first machine learning model, further comprises:
determining a probability that the first account exhibits the first pre-determined behavior based on the first entity graph; and
determining the first account exhibits the first pre-determined behavior based on the probability.

3. The method of claim 1, wherein determining using the second machine learning model, further comprises:
determining an m-dimensional vector space based on the n-dimensional vector space;
generating the first entity embedding and the second entity embedding in the m-dimensional vector space;
determining a vector distance between the first entity embedding and the second entity embedding in the m-dimensional vector space;
determining that the vector distance is within a vector proximity threshold; and
determining the first account exhibits the second pre-determined behavior based on the vector distance being within the vector proximity threshold.

4. The method of claim 3, wherein the m-dimensional vector space is less than the n-dimensional vector space.

5. The method of claim 3, wherein the second machine learning model is an auto encoder.

6. The method of claim 1, further comprising:
determining, using a third machine learning model in the ensemble of machine learning models and based on a sequence of a third set of parameters in the plurality of first account parameters, that the first account exhibits a third pre-determined behavior; and
wherein determining that the first account exhibits the pre-determined behavior is further based on the third pre-determined behavior.

7. The method of claim 6, wherein determining, using the third machine learning model, further comprises:
generating a sequence of activity associated with the first account based on the third set of parameters in the plurality of first account parameters;
determining, using a Recurrent Neural Network (RNN) model a probability that the sequence of activity is associated with the third pre-determined behavior; and
determining that the first account exhibits the third pre-determined behavior based on the probability.

8. The method of claim 7, wherein the RNN is a Long Short-Term Memory (LSTM) model.

9. The method of claim 1, wherein the second set of parameters are captured within a predefined time from a time the first account is opened.

10. The method of claim 1, further comprising:
receiving a training dataset that comprises a first training entity having the first pre-determined behavior and a first training graph, and a second training entity not having the first pre-determined behavior and a second training graph;
demarcating a first decision boundary associated with the first machine learning model based on the first training graph and the second training graph, the first decision boundary delineating the boundary between entities that exhibit the first pre-determined behavior and entities that do not exhibit the first pre-determined behavior; and
determining that the first account exhibits the first pre-determined behavior based on a position of the first entity graph relative to the first decision boundary.

11. The method of claim 1, further comprising:
receiving a training dataset that comprises a set of training entities that includes entities that exhibit the second pre-determined behavior and entities that do not exhibit the second pre-determined behavior;
determining vector embeddings for the set of training entities in the n-dimensional vector space to identify the entities in the training dataset that exhibit the second pre-determined behavior;
determining the second entity embedding that corresponds to the second pre-determined behavior in the n-dimensional vector space;
determining a vector distance between the first entity embedding and the second entity embedding in the n-dimensional vector space;
determine whether the vector distance is within a proximity threshold; and
based on the vector distance being within the proximity threshold, determining the first account exhibits the second pre-determined behavior.

12. The method of claim 1, further comprising:
receiving a training dataset comprising a first training entity having the third pre-determined behavior and a first account activity parameter and a second training entity not having the third pre-determined behavior and a second account activity parameter;
demarcating a third decision boundary associated with the third machine learning model, the third decision boundary delineating the transition between the first entity with the third pre-determined behavior and the second entity that does not exhibit the third pre-determined behavior in the third machine learning model; and
determining that the first account exhibits the third pre-determined behavior based on a position of the sequence of one or more of the plurality of first account parameters in the third machine learning model relative to the third decision boundary.

13. The method of claim 1, wherein the plurality of first account parameters are associated with a transaction on an electronic transaction platform.

14. A system, comprising:
a non-transitory memory; and
one or more hardware processors coupled to the non-transitory memory and configured to read instructions from the non-transitory memory to cause the system to perform operations comprising:
determining, using a first machine learning model, that a first account associated with a first entity exhibits a first pre-determined behavior based on a first entity graph;
determining, using a second machine learning model, that the first account exhibits a second pre-determined behavior based a vector proximity between a first entity embedding and a second entity embedding in an n-dimensional vector space, wherein the first entity embedding is based on a first account of the first entity and the second entity embedding is associated with a second account that exhibits the second pre-determined behavior;
determining, using a third machine learning model, that the first account exhibits a third pre-determined behavior based on a sequence of first account parameters associated with the first entity; and
determining the first account exhibits the pre-determined behavior based on one or more of the first pre-determined behavior, the second pre-determined behavior, the third pre-determined behavior.

15. The system of claim 14, wherein determining using the first machine learning model, further comprises:
generating the first entity graph based on account parameters associated with the first entity;
determining a probability that the first entity exhibits the first pre-determined behavior based on the first entity graph; and
determining the first account exhibits the first pre-determined behavior based on the probability.

16. The system of claim 14, wherein determining using the second machine learning model, further comprises:
determining an m-dimensional vector space based on the n-dimensional vector space, wherein the m-dimensional vector space is less than the n-dimensional vector space;
determining a vector distance between the first entity embedding and the second entity embedding in the m-dimensional vector space;
determining that the vector distance is within a vector proximity threshold; and
determining the first account exhibits the first pre-determined behavior based on the vector distance being within the vector proximity threshold.

17. The system of claim 16, wherein the second machine learning model is a graphical neural network.

18. The system of claim 14, wherein determining using the third machine learning model, further comprises:
generating a sequence of activity associated with the first account based on the sequence of the first account parameters;
determining, via a Long Short-Term Memory (LSTM) model, a probability that the sequence of activity is associated with the third pre-determined behavior; and
determining that the first account exhibits the first pre-determined behavior based on the probability.

19. A non-transitory machine-readable medium having stored thereon machine-readable instructions executable to cause a machine to perform operations comprising:
receiving a plurality of account parameters associated with an entity;
determining, using a first layer of a machine learning model, that an account exhibits a first pre-determined behavior based on an entity graph, wherein the entity graph is based on at least one of the plurality of account parameters;
determining, using a second layer of the machine learning model, that the account exhibits a second pre-determined behavior based on a vector proximity between an entity embedding and a second entity embedding in an n-dimensional vector space of the machine learning model, wherein the entity embedding is associated with the account and the second entity embedding is associated with another account that exhibits the second pre-determined behavior;
determining, using a third layer of the machine learning model, that the account exhibits a third pre-determined behavior based on a sequence of one or more of the plurality of account parameters; and
determining the account exhibits the pre-determined behavior based on the first pre-determined behavior, the second pre-determined behavior, or the third pre-determined.

20. The non-transitory machine-readable medium of claim 19, wherein the first layer of the machine learning model is based on a graphical neural network, the second layer of the machine learning model is based on an auto encoder network, and the third layer of the machine learning model is based on an LSTM network.
